(19) United States
(12) Patent Application Publication
(10) Pub. No.: US 2014/0188585 A1
(43) Pub. Date: Jul. 3, 2014

(54) Organizational Tools and or a Collaboration System Utilizing the Same Therein

(71) Applicant: Solomon Thompson, JR., Fairfax, VA (US)

(72) Inventors: Solomon Thompson, JR., Fairfax, VA (US); Frank Sedor, Bristol, RI (US); Brandon Raines, Clifton, VA (US); John Wright, Flatwoods, KY (US); Shashonna Smith, Centerville, VA (US); Natalie Guthrie, Herndon, VA (US); Gene Redecker, Ashland, KY (US); Choa-Chong Lee, Herndon, VA (US); Gregory Perrier, Centerville, VA (US); David Lindsay, Annandale, VA (US)

(73) Assignee: Solomon Thompson, JR., Fairfax, VA (US)

(21) Appl. No.: 14/199,128

(22) Filed: Mar. 6, 2014

Related U.S. Application Data
(63) Continuation-in-part of application No. 13/969,367, filed on Aug. 16, 2013.
Application No. 13/969,367 is a continuation-in-part of application No. 13/969,346, filed on Aug. 16, 2013.
Application No. 13/969,367 is a continuation-in-part of application No. 13/491,314, filed on Jun. 7, 2012.
Application No. 13/969,346 is a continuation-in-part of application No. 13/491,314, filed on Jun. 7, 2012.
(60) Provisional application No. 61/494,020, filed on Jun. 7, 2011.

(51) Int. Cl. G06Q 30/02

(52) U.S. Cl. CPC G06Q 30/0214
USPC 705/14.16

(57) ABSTRACT

A method of automating aspects of charging and receiving payments in exchange for access to a user's content on a collaboration system configured for use on a server accessible by a network such that paid access can be readily established without requiring the independent integration of payment receipt and tracking software by the user and without requiring the user to determining software compatibility of the same for use on the server.

### CROSS REFERENCE TO RELATED APPLICATIONS

This application claims benefit of and priority to and is a continuation in part of: (1) U.S. patent application 13/969,367, filed Aug. 16, 2013; (3) U.S. patent application 13/969,346, filed Aug. 16, 2013; (3) U.S. patent application 13/491,314, filed Jun. 7, 2012; and claims priority to and benefit of (4) U.S. provisional patent application 61/494,020, filed on Jun. 7, 2011; each of the above-identified applications is hereby incorporated by reference herein as if set forth in its entirety.

### BACKGROUND

The present invention is generally directed to collaboration software and, more specifically, to collaboration software that allows users to tailor functionality and workflow to their specific needs, that provides some tools not previously available, and/or that improves coordination between users.

Current software solutions for collaboration are tailored for use on specific problems. Accordingly, current solutions tend to use a limited number of predetermined workflows based on certain data structures. This requires that different users need to seek out particular software tailored to their particular needs or to prepare tailored programming solutions to enable optimal workflow.

It may be advantageous to provide a collaboration system having a collection of application tools and collaboration tools which allow users to generate customized workflows depending on the particular project at hand, having new collaboration tools, having the ability to incorporate voting into predetermined data constructs, which can create checklist or task lists in already existing data structures, and/or allowing gathering of personal data into a file which can be viewed regardless of the virtual place in which a user is interfacing with the collaboration system.

### SUMMARY

Briefly speaking, one embodiment of the present invention is directed to a collaboration system including a server including a computer readable medium having a software module thereon configured to provide collaboration tools accessible by multiple users over a network. A first data file is located on the server and is configured to represent collaborative information in the form of at least one of a task, discussion topic, and document for approval. The first data file is created in response to user instructions. The software module is configured to receive instructions from at least one of the multiple users to transform the first data file to allow for votes to be collected and stored on the server in connection with the collaborative data in the first data file. The software module is configured to transform the first data file into a modified first data file which includes vote information wherein the multiple users submit votes via the network and the server stores the voting data in the modified first data file.

In a separate aspect, one embodiment of the present invention is directed to a method of organizing user associated information for a server hosted collaboration system accessible by a network. The method including the steps of: providing at least one software module stored on a non-transitory computer readable storage medium which provides collaboration tools which that be accessed by a user via a network; receiving information relating to the user via use of one of the collaboration tools and storing the information on a server; generating a personal data file representing at least one of the group of a summary of the received information, the collaboration tool used to input the information, a summary of the received information, and an identification of the type of received information; and transmitting a presentation of the personal data file to the user which allows the user to view information provided to the server hosted collaboration system.

In a separate aspect, one embodiment of the present invention is directed to a computer readable medium having stored thereon a plurality of instructions which, when executed by the processor of a computer system, cause the processor to perform the steps of: providing a collaboration tool adapted to be accessed by a user over a network; creating a first data file in response to instructions received by the user via one of the collaboration tools, the first data file is configured to represent collaborative information in the form of at least one of: a task, discussion topic, and document for approval; receiving instructions from a user over the network to modify the first data file via the collaboration tool; and transforming the first data file into a modified data file in which at least one portion of the collaborative information includes a checklist.

In a separate aspect, one embodiment of the present invention is directed to a computer readable medium having stored thereon a plurality of instructions which, when executed by the processor of a computer system, cause the processor to perform the steps of: providing a collaboration system accessible by multiple users over a network, the collaboration system including a plurality of virtual places each representing a separate location for storing grouped data; providing a collaboration tool for purchase by a first user, the collaboration tool can be used to at least one of the group of: create data, transform data, and retrieve data from virtual places; receiving payment from the first user and allowing the first user to operate the collaboration tool in any virtual place created by the first user; and allowing a second user to purchase the collaborative tool for use in at least one of the virtual places created by the first user, when a purchase of the collaborative tool is made by the second user for use in one of the virtual places created by the first user, a predetermined percentage of the payment is credited to the first user.

In a separate aspect, one embodiment of the present invention is directed to a computer readable medium having stored thereon a plurality of instructions which, when executed by the processor of a computer system, cause the processor to perform the steps of: providing a collaboration system adapted to be accessed by a user over a network that enables the user to create customized workflow to address a specific collaborative situation using established collaboration tools; providing a virtual place creation tool adapted to create a virtual space representing grouped data, the virtual place creation tool being operable in response to instructions received from the user via the network; providing a topic creation tool adapted to originate a set of linked information relating to a desired topic, the topic creation tool being operable in response to instructions received from the user via the network; providing a checklist creation tool adapted to generate at least one of the group of: a list of standalone tasks; and to create a list of tasks within a preexisting data file, the checklist creation tool being operable in response to instructions received from the user via the network; providing a voting creation tool adapted to modify a preexisting data file to include voting information, the voting creation tool being operable in response to instructions received from the user via the network; providing a document creation tool adapted to link a document with a at least one of the group of: a preexisting data file and a virtual place, the document creation tool being operable in response to instructions received from the user via the network; receiving instructions from the user via the network and creating a first data file using any one of the group of: the virtual place creation tool, the topic creation tool, the checklist creation tool, the voting creation tool, and the document creation tool; receiving additional instructions from the user to modify the first data file using at least one of the group of: the virtual place creation tool, the topic creation tool, the checklist creation tool, the voting creation tool, and the document creation tool to create a customized data file, wherein the collaboration system is configured to allow the user to create a customized data file representing the workflow desired by the user to solve the particular collaborative problem.

In a separate aspect, one embodiment of the present invention is directed to a collaboration system including a server including a computer readable medium having a software module thereon configured to provide collaboration tools accessible by multiple users over a network. The first data file on the server is configured to represent collaborative information of any sort. The first data file is created in response to user instructions submitted via the network. The software module being configured to receive instructions from at least one of the multiple users to transform the first data file to allow for votes to be collected and stored on the server in connection with the collaborative data in the first data file. The software module being configured to transform the first data file into a modified first data file capable of including vote information. The software module being configured to receive votes from the multiple users via the network. The software module being configured to store the vote information in the modified first data file.

In a separate aspect, one embodiment of the present invention is directed to a method of organizing user associated information for a server hosted collaboration system accessible by a network, including the steps of: providing at least one software module stored on a non-transitory computer readable storage medium which provides collaboration tools which can be accessed by a user via a network; in response to receiving information relating to a user via use of one of the collaboration tools, storing the information on the server; generating a personal data file representing at least one of the group of a summary of the received information, the collaboration tool used to input the information, a summary of the received information, and an identification of the type of received information; and in response to instructions received from the user transmitting a presentation of the personal data file to the user which allows the user to view information provided to the server hosted collaboration system.

In a separate aspect, one embodiment of the present invention is directed to a computer readable medium having stored thereon a plurality of instructions which, when executed by the processor of a computer system, cause the processor to perform the steps of: providing a collaboration tool adapted to be accessed by a user over a network; in response to receiving instructions from a user over the network creating a first data file, the first data file is configured to represent collaborative information in the form of at least one of: a task, a discussion topic, and a document for approval; in response to receiving instructions from the user over the network to modify the first data file via the collaboration tool; and transforming the first data file into a modified data file in which at least one portion of the collaborative information includes a checklist.

In a separate aspect, one embodiment of the present invention is directed to a computer readable medium having stored thereon a plurality of instructions which, when executed by the processor of a computer system, cause the processor to perform the steps of: providing a collaboration system accessible by multiple users over a network, the collaboration system including a plurality of virtual places each representing a separate location for storing data; providing a collaboration tool for purchase by a first user, the collaboration tool can be used to at least one of the group of: create data, transform data, and retrieve data from at least one of the plurality of virtual places; in response to receiving payment from the first user and allowing the first user to operate the collaboration tool in any of the plurality of virtual places created by the first user; in response to allowing a second user to purchase the collaborative tool for use in at least one of the many virtual places created by the first user when a purchase of the collaborative tool is made by the second user, a predetermined percentage of the payment is credited to the first user.

In a separate aspect, one embodiment of the present invention is directed to a computer readable medium having stored thereon a plurality of instructions which, when executed by the processor of a computer system, cause the processor to perform the steps of: providing a collaboration system adapted to be accessed by a user over a network that enables the user to create customized workflow to address a specific collaborative situation using established collaboration tools; providing a virtual place creation tool adapted to create a virtual space representing grouped data, the virtual place creation tool being operable in response to instructions received from the user via the network; providing a topic creation tool adapted to originate a set of linked information relating to a desired topic, the topic creation tool being operable in response to instructions received from the user via the network; providing a checklist creation tool adapted to generate at least one of the group of: a list of standalone tasks; and to create a list of tasks within a preexisting data file, the checklist creation tool being operable in response to instructions received from the user via the network; providing a voting creation tool adapted to modify a preexisting data file to include voting information, the voting creation tool being operable in response to instructions received from the user via the network; providing a document creation tool adapted to link a document with a at least one of the group of: a preexisting data file and a virtual place, the document creation tool being operable in response to instructions received from the user via the network; in response to receiving instructions from the user via the network creating a first data file using any one of the group of: the virtual place creation tool, the topic creation tool, the checklist creation tool, the voting creation tool, and the document creation tool; in response to receiving additional instructions from the user to transform the first data file using at least one of the group of: the virtual place creation tool, the topic creation tool, the checklist creation tool, the voting creation tool, and the document creation tool to create a customized data file, wherein the collaboration system is configured to allow the user to create the customized data file representing the workflow desired by the user to solve the particular collaborative problem.

In a separate aspect, one embodiment of the present invention is directed to a computer readable medium having stored thereon a plurality of instructions which, when executed by the processor of a computer system, cause the processor to perform the steps of: providing collaboration tools accessible by multiple users over a network; in response to receiving instructions from a user via the network creating a first data file on the server configured to represent collaborative information of any sort; in response to receiving instructions from at least one of the multiple users via the network transforming the first data file to allow for votes to be collected and stored on the server in connection with the collaborative information in the first data file; in response to receiving votes modifying the first data file to include the votes.

In a separate aspect, one embodiment of the present invention is directed to a computer readable medium having stored thereon a plurality of instructions which, when executed by the processor of a computer system, cause the processor to perform the steps of: providing a collaboration system and associated tools adapted to be accessed by a user over a network that enables the user to create customized workflow to address a specific project using established collaboration tools so that a user can create a unique and/or customized workflow desired by the user to solve the specific project without needing to write any actual programming code.

In another aspect, the present invention is directed to a method of organizing revenues for user shares of information regarding applications configured for use on a server hosted collaboration system accessible by a network. The method including the steps of: providing at least one software module stored on a non-transitory computer readable storage medium which provides collaboration tools which can be accessed by a user via a network, one of the collaboration tools being the ability to create a checklist in which each item can be assigned to an individual user, wherein the collaboration system provides a plurality of virtual places each of which is configured to require different credentials for access by the user and each having an associated graphical user interface associated therewith, each virtual place being originally created by a first user who can invite other users to enter the virtual place on the network to access data stored therein and use any of the collaborative tools available within the virtual place, other users can use any of the available collaborative tools to provide more data within the virtual place, wherein the collaboration system is configured to allow the users to apply the collaboration tools to define and complete a business oriented project while allowing the users to create a customized workflow to complete the project; in response to receiving information in one of the plurality of virtual places relating to a user via use of one of the collaboration tools, storing the information on the server; providing at least another software module stored on the non-transitory computer readable storage medium which provides applications which can be accessed by the user via the network, wherein use and operation of an application is authorized based on the one of the virtual places for which payment is received by the network in order to operate the application therein, allowing a user to initiate sharing of information regarding an application such that the collaboration system sends information about the application to a specific target audience via an electronic communication, automatic monitoring by the network as to whether a member of the specific target audience purchases the application for which information was shared by the user, automatic tracking by the network of purchases resulting from the sharing of information by the user and crediting a portion of the revenue from the purchases to the user; generating a personal data file by the network representing a complete collection of the received information entered by the user into the server hosted collaboration system regardless of the particular one of the plurality of virtual places in which the received information was received, the personal data file also containing information regarding revenue sharing with the user based on purchases resulting from the sharing of information about the application by the user; and in response to instructions received from the user transmitting a presentation of the personal data file to the user which allows the user to, while interacting with the network via one of the plurality of virtual places, view the collection of received information provided to the server hosted collaboration system regardless of whether the received information is in one or more of the plurality of virtual places, wherein presentation of the personal data file is viewed from the graphical user interface associated with the particular virtual place in which the user is currently located, the presentation of the personal data file allowing the user to view and access any of the user's received information regardless of the credentials necessary to access the particular virtual places in which the received information are stored; selecting a portion of the collection of received information within the presentation by the user; receiving a complete copy of the selected portion of the collection of received information without necessarily having to enter the virtual place in which the selected portion of the collection of received information is stored.

In another aspect, the present invention is directed to a method of organizing revenues for user shares of information regarding applications configured for use on a server hosted collaboration system accessible by a network. The method includes: providing at least one software module stored on a non-transitory computer readable storage medium which provides collaboration tools which can be accessed by a user via a network, one of the collaboration tools being the ability to create a checklist in which each item can be assigned to an individual user, wherein the collaboration system provides a plurality of virtual places each of which is configured to require different credentials for access by the user and each having an associated graphical user interface associated therewith, each virtual place being originally created by a first user who can invite other users to enter the virtual place on the network to access data stored therein and use any of the collaborative tools available within the virtual place, other users can use any of the available collaborative tools to provide more data within the virtual place, wherein the collaboration system is configured to allow the users to apply the collaboration tools to define and complete a business oriented project while allowing the users to create a customized workflow to complete the project; providing at least another software module stored on the non-transitory computer readable storage medium which provides applications which can be accessed by the user via the network, wherein use and operation of an application is authorized based on the one of the virtual places for which payment is received by the network in order to operate the application therein, allowing a user to initiate sharing of information regarding an application such that the collaboration system sends information about the application to a specific target audience via an electronic communication, automatic monitoring by the network as to whether a member of the specific target audience purchases the application for which information was shared by the user, automatic tracking by the network of purchases resulting from the sharing of information by the user and crediting a portion of the revenue from the purchases to the user.

In another aspect, the present invention is directed to a method of organizing revenues for user shares of information regarding applications configured for use on a server hosted collaboration system accessible by a network. The method includes: providing at least one software module stored on a non-transitory computer readable storage medium which provides collaboration tools which can be accessed by a user via a network, one of the collaboration tools being the ability to create a checklist in which each item can be assigned to an individual user, wherein the collaboration system provides a plurality of virtual places each of which is configured to require different credentials for access by the user and each having an associated graphical user interface associated therewith, each virtual place being originally created by a first user who can invite other users to enter the virtual place on the network to access data stored therein and use any of the collaborative tools available within the virtual place, other users can use any of the available collaborative tools to provide more data within the virtual place, wherein the collaboration system is configured to allow the users to apply the collaboration tools to define and complete a business oriented project while allowing the users to create a customized workflow to complete the project; providing at least another software module stored on the non-transitory computer readable storage medium which provides applications which can be accessed by the user via the network, wherein use and operation of an application is authorized based on the one of the virtual places for which payment is received by the network in order to operate the application therein, allowing a user to initiate sharing of information regarding an application such that the collaboration system sends information about the application to a specific target audience via an electronic communication in the form of a link embedded in an email which can be selected by a recipient of the email, automatic monitoring by the network as to whether a member of the specific target audience purchases the application for which information was shared by the user, automatic tracking by the network of purchases resulting from the sharing of information by the user and crediting a portion of the revenue from the purchases to the user.

In another aspect, the present invention is directed to a method of organizing revenues for user shares of information regarding applications configured for use on a server hosted collaboration system accessible by a network. The method includes: providing at least one software module stored on a non-transitory computer readable storage medium which provides collaboration tools which can be accessed by a user via a network, wherein the collaboration system provides a plurality of virtual places each having an associated graphical user interface associated therewith, each virtual place being originally created by a first user who can invite other users to enter the virtual place on the network to access data stored therein and use any of the collaborative tools available within the virtual place, other users can use any of the available collaborative tools to provide more data within the virtual place, wherein the collaboration system is configured to allow the users to apply the collaboration tools to define and complete a business oriented project while allowing the users to create a customized workflow to complete the project; providing at least another software module stored on the non-transitory computer readable storage medium which provides applications which can be accessed by the user via the network, wherein use and operation of an application is authorized based on the one of the virtual places for which payment is received by the network in order to operate the application therein, allowing a user to initiate sharing of information regarding an application such that the collaboration system sends information about the application to a specific target audience via an electronic communication, automatic monitoring by the network as to whether a member of the specific target audience purchases the application for which information was shared by the user, automatic tracking by the network of purchases resulting from the sharing of information by the user and crediting a portion of the revenue from the purchases to the user.

In another aspect, the present invention is directed to a method of organizing revenues for user shares of information regarding applications configured for use on a server hosted collaboration system accessible by a network. The method includes: providing at least one software module stored on a non-transitory computer readable storage medium which provides collaboration tools which can be accessed by a user via a network, wherein the collaboration system provides a plurality of virtual places each having an associated graphical user interface associated therewith; providing at least another software module stored on the non-transitory computer readable storage medium which provides applications which can be accessed by the user via the network, wherein use and operation of an application is authorized based on the one of the virtual places for which payment is received by the network in order to operate the application therein, allowing a user to initiate sharing of information regarding an application such that the collaboration system sends information about the application to a specific target audience via an electronic communication, automatic monitoring by the network as to whether a member of the specific target audience purchases the application for which information was shared by the user, automatic tracking by the network of purchases resulting from the sharing of information by the user and crediting a portion of the revenue from the purchases to the user.

In another aspect, the present invention is directed to a method of organizing revenues for user shares of information regarding applications configured for use on a server hosted collaboration system accessible by a network. The method includes: providing at least one software module stored on the non-transitory computer readable storage medium which provides applications which can be accessed by the user via the network, wherein use and operation of an application is authorized based on payment received by the network in order to operate the application, allowing a user to initiate sharing of information regarding an application such that the collaboration system sends information about the application to a specific target audience via an electronic communication, automatic monitoring by the network as to whether a member of the specific target audience purchases the application for which information was shared by the user, automatic tracking by the network of purchases resulting from the sharing of information by the user and crediting a portion of the revenue from the purchases to the user.

In another aspect, the present invention is directed to a method of organizing revenues for user shares of information regarding applications configured for use on a server hosted collaboration system accessible by a network. The method includes: providing at least one software module stored on the non-transitory computer readable storage medium which provides applications which can be accessed by the user via the network, wherein use and operation of an application is authorized based on payment received by the network in order to operate the application, allowing a user to initiate sharing of information regarding the application such that the collaboration system sends information about the application to at least one person via an electronic communication, automatic tracking by the network of purchases resulting from the sharing of information by the user and crediting a portion of the revenue from the purchases to the user.

In another aspect, the present invention is directed to a method of organizing revenues for user shares of information regarding applications configured for use on an electronic device. The method includes: providing at least one software module stored on the non-transitory computer readable storage medium which provides applications which can be accessed by the user via the electronic device, wherein use and operation of an application is authorized based on payment, allowing a user to initiate sharing of information regarding the application such that the collaboration system sends information about the application to at least one person via an electronic communication, automatic tracking of purchases resulting from the sharing of information by the user and crediting a portion of the revenue from the purchases to the user.

In another aspect, one embodiment of the present invention is directed to a method of organizing revenues for user shares of information regarding applications configured for use on a server accessible by a network. The method including: providing at least one software module stored on a non-transitory computer readable storage medium which provides applications which can be accessed by a user via the network, wherein use and operation of an application is authorized based on payment received by the network in order to operate the application therein, allowing a user to send information about the application to a specific target audience via an electronic communication, automatic monitoring by the network as to whether a member of the specific target audience purchases the application for which information was shared by the user, automatic tracking by the network of purchases resulting from the sharing of information by the user and crediting a portion of the revenue from the purchases to the user.

In another aspect, the present invention is directed to a method of organizing revenues for user shares of information regarding applications configured for use on a server system accessible by an electronic processing device. the method including: providing at least one software module stored on a non-transitory computer readable storage medium which provides applications which can be accessed by a user via the electronic processing device, wherein use and operation of an application is authorized based on payment received by the server system in order to operate the application thereon, allowing a user to send information about the application to a specific target audience via an electronic communication, automatic monitoring by the server system as to whether a member of the specific target audience purchases the application for which information was shared by the user, automatic tracking by the server system of purchases resulting from the sharing of information by the user and crediting a portion of the revenue from the purchases to the user.

In another aspect, the present invention is directed to a method of organizing revenues for user shares of information regarding applications configured for use on a server system accessible by an electronic device. The method including: providing at least one software module stored on a non-transitory computer readable storage medium which provides applications which can be accessed by a user via the electronic device, wherein use and operation of an application is authorized based on payment received by the server system in order to operate the application thereon, allowing a user to send information about the application to a specific target audience via an electronic communication, automatic monitoring by the server system as to whether a member of the specific target audience purchases the application for which information was shared by the user, automatic tracking by the server system of purchases resulting from the sharing of information by the user and crediting a portion of the revenue from the purchases to the user.

In a separate aspect, a method of the present invention is directed to automating aspects of charging and receiving payments in exchange for access to a user's content on a collaboration system configured for use on a server accessible by a network such that paid access can be readily established without requiring the independent integration of payment receipt and tracking software by the user and without requiring the user to select and determine software compatibility of the same for use on the server. The method including the steps of: providing at least one software module stored on a non-transitory computer readable storage medium which provides collaboration tools which can be accessed by the user via the network, the collaboration system provides a plurality of virtual places each of which is configured to require different credentials for access and each having a graphical user interface associated therewith, each virtual place being originally created by a first user who can one of invite and allow other users to enter the virtual place on the network to access data stored therein and/or use any of the collaborative tools available within the virtual place, the network provides a collaboration tool to the first user which allows the first user to set payment terms for access by other users to the virtual place created by the first user, this allows the first user to by selecting a single collaborative tool modify the virtual place so that the virtual place charges for access without the first user having to separately and independently identify and select appropriate software for virtual shopping carts, merchant services, and payment tracking, this allows the first user to by using a single tool change the virtual place to then require payment for access to the virtual place, the network automatically monitoring the payment terms and allowed access to the virtual place and being configured to readily receive and track payments from other users who wish to pay and receive access to the virtual place owned by the first user.

In a separate aspect, a method of the present invention is directed to automating aspects of charging and receiving payments in exchange for access to a user's content on a collaboration system configured for use on a server accessible by a network such that paid access can be readily established without requiring the independent integration of payment receipt and tracking software by the user and without requiring the user to select and determine software compatibility of the same for use on the server. The method including the steps of: the network provides a collaboration tool to the first user which allows the first user to set payment terms for access by other users to the virtual place created by the first user, this allows the first user to by selecting a single collaborative tool modify the virtual place so that the virtual place charges for access without the first user having to separately and independently identify and select appropriate software for virtual shopping carts, merchant services, and payment tracking, this allows the first user to by using a single tool change the virtual place to then require payment for access to the virtual place, the network automatically monitoring the payment terms and allowed access to the virtual place and being configured to readily receive and track payments from other users who wish to pay and receive access to the virtual place owned by the first user.

In a separate aspect, a method of the present invention is directed to automating aspects of charging and receiving payments in exchange for access to a user's content on a collaboration system configured for use on a server. The method including the steps of: the network provides a collaboration tool to the first user which allows the first user to set payment terms for access by other users to the virtual place created by the first user, this allows the first user to by selecting a single collaborative tool modify the virtual place so that the virtual place charges for access without the first user having to separately and independently identify and select appropriate additional technical solutions compatible with the collaboration system, this allows the first user to by using a single tool change the virtual place to then require payment for access to the virtual place, the network automatically monitoring the payment terms and allowed access to the virtual place and being configured to readily receive and track payments from other users who wish to pay and receive access to the virtual place owned by the first user.

In a separate aspect, a method of the present invention is directed to automating aspects of charging and receiving payments in exchange for access to a user's content on a collaboration system configured for use on a server. The method including the steps of: the network provides a collaboration tool to the first user which allows the first user to set payment terms for access by other users to the virtual place created by the first user, this allows the first user to by selecting a single collaborative tool modify the virtual place so that the virtual place charges for access, this allows the first user to by using a single tool change the virtual place to then require payment for access to the virtual place, the network automatically monitoring the payment terms and allowed access to the virtual place and being configured to readily receive and track payments from other users who wish to pay and receive access to the virtual place owned by the first user.

In a separate aspect, the present invention is directed to a dollar place app (application) for use with a collaboration system or social networking system that may allow the purchaser of the dollar place app to assign the app to a virtual place (or a group on a social networking system) to thereby give the purchaser the power to charge for membership to the virtual place (or group). The application may include: the ability to assign and update a price for membership; the ability to share revenues.

In a separate aspect, the present invention is directed to a dollar place app (application) for use with a collaboration system or social networking system that enables any member to set up any number of virtual places (or groups) and charge an entry fee where the entry fee is shared between the seller, the virtual place/group owner and the operator (which could be the operator of the website/network/collaboration system/social networking system).

In a separate aspect, the present invention allows a party to charge a membership fee for people that join the party's group. In the below described collaboration system, the notion of a group is called a virtual place. This invention makes it extremely simple for a layperson to collect money from a group of individuals interested in joining their site without needing to deal with IT or payment complexities (except setting possibly up a paypal account). Additionally, the site, preferably provides a record of all of the monetary transactions such that they can handle IRS and other reporting requirements simply. As such the present invention may shield virtual place owners from IT, payment and reporting complexities while providing virtual place owner's a fast way to setup a money making venture.

### BRIEF DESCRIPTION OF THE DRAWINGS

The following detailed description of the preferred embodiments of the present invention will be better understood when read in conjunction with the appended drawings. For the purpose of illustrating the invention, there are shown in the drawings embodiments which are presently preferred. It is understood, however, that the invention is not limited to the precise arrangements and instrumentalities shown. In the drawings:

FIG. 1 is a flowchart of a preferred method of the present invention directed to integrating voting capability and data into a preexisting data construct within a collaboration system;

FIG. 2 is a flowchart of a preferred method of the present invention directed to generating and transmitting a personal data file based on use of a collaboration system;

FIG. 3 is a flowchart of a preferred method of the present invention directed to integrating a checklist into a preexisting data construct within a collaboration system;

FIG. 4 is a flowchart of a preferred method of the present invention directed to a unique payment method for the use of collaboration tools within a collaboration system;

FIG. 5 is a flowchart of a preferred method of the present invention directed to modifying a preexisting data construct using a custom selection of collaboration tools to make a customized workflow construct for addressing a specific problem;

FIG. 6 is a schematic illustrating preferred typical software component interactions and workflow when a user is posting data to the collaboration system;

FIG. 7 is a schematic illustrating preferred typical software component interactions when a user receives presented data from the collaboration system;

FIG. 8 is an illustration of an exemplary graphical user interface which may be presented to a user that represents the entire public community space on the collaboration system server;

FIG. 9 illustrates a partial view of the preferred graphical user interface displaying a create a virtual place menu;

FIG. 10 is illustrates an exemplary graphical user interface displaying a virtual place that has been created by a user by submitting instructions over a network;

FIG. 11 illustrates an example of a graphical user interface presentation to a user for a Timecard Approve/Reject Worklist constrained by containing “SRC” in the Contract Name and “Start Date=2011-05-21”;

FIG. 12 illustratees an exemplary graphical user interface is a Referring to FIG. 12 an example of Timecard Approve/Reject screen is shown which would preferably have sufficient information visible on the screen to enable the authorized user to make a decision to Approve or Reject the Timecard(s).

FIG. 13 illustrates an exemplary screen that can be presented to a user when a user creates a topic; the create a topic interface may include web content composed of text and graphics (similar to wiki topics) which could describe ideas or proposals;

FIG. 14 illustrates an exemplary screen presented to a user when a topic is created which may be directed to collecting feedback on any topic to leverage crowd inputs to mature the idea of the topic owner;

FIG. 15 is an exemplary screen/graphical user interface showing a modified data file which represents a topic that have been transformed to incorporate and store voting information;

FIG. 16 illustrates an exemplary graphical user interface for a checklist in which different tasks have been assigned to different user;

FIG. 17 illustrates a preferred graphical user interface for the collaboration system of the present invention showing a backpack icon in the upper left corner which can be selected by a user to activate a virtual backpack tool; the virtual backpack tool can be used to generate and display a personal data file in response to user instructions transmitted via the network; The user data can be filtered or selectively displayed by the collaboration system in response to further user instructions;

FIG. 18 illustrates an exemplary menu on the graphical user interface that presents itself to a user in response to a request for the personal data file; As shown in this example it is possible to present the user with choices to allow the user to filter which data in the personal user file is presented to the user; The choice of filters or the option to show all data at once can be used with the collaboration system of the present invention without departing from the scope of the present invention; and

FIG. 19 illustrates an exemplary presentation of the personal data file filtered in response to user instructions.

### DETAILED DESCRIPTION OF THE PREFERRED EMBODIMENTS

Certain terminology is used in the following description for convenience only and is not limiting. The language “at least one of ‘A’, ‘B’, and ‘C’,” as used in the claims and in corresponding portions of the specification, means “any group having at least one ‘A’; or any group having at least one ‘B’; or any group having at least one ‘C’;—and does require that a group have at least one of each of ‘A’, ‘B’, and ‘C’.” The term “collaborative information”, as used in the specification and claims, is understood to mean “information that is generated collaboratively or that is being provided for use on a collaborative system even though generated by a single individual”. Additionally, the words “a” and “one” are defined as including one or more of the referenced item unless specifically stated otherwise. The terminology includes the words above specifically mentioned, derivatives thereof, and words of similar import.

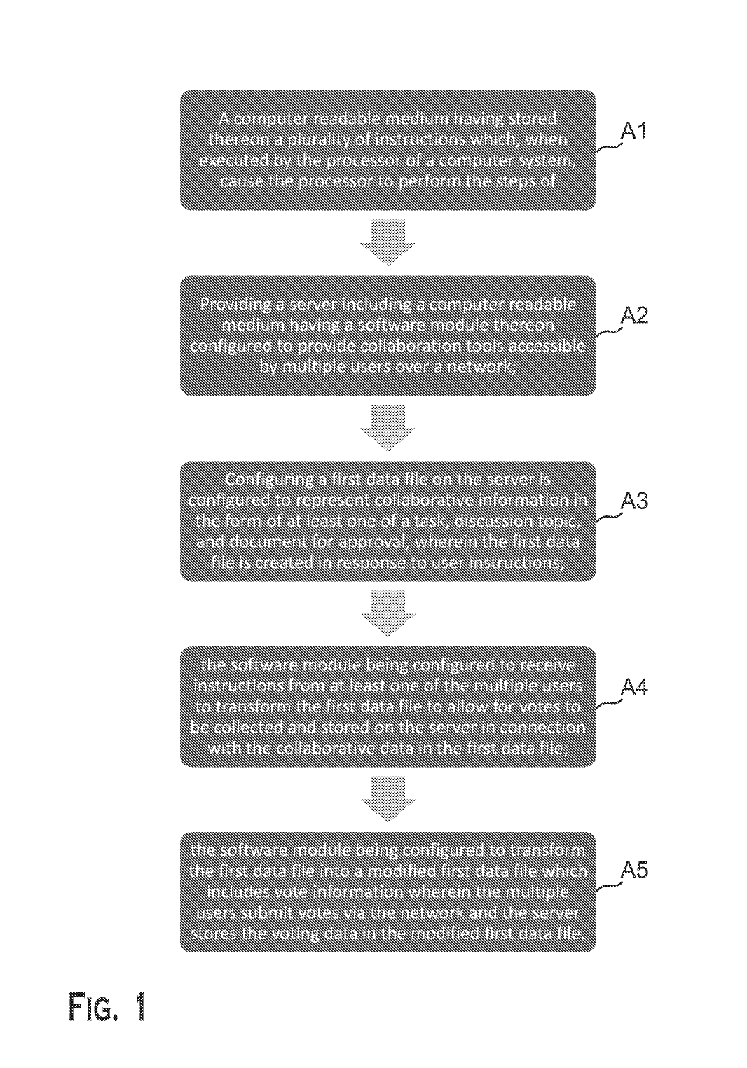

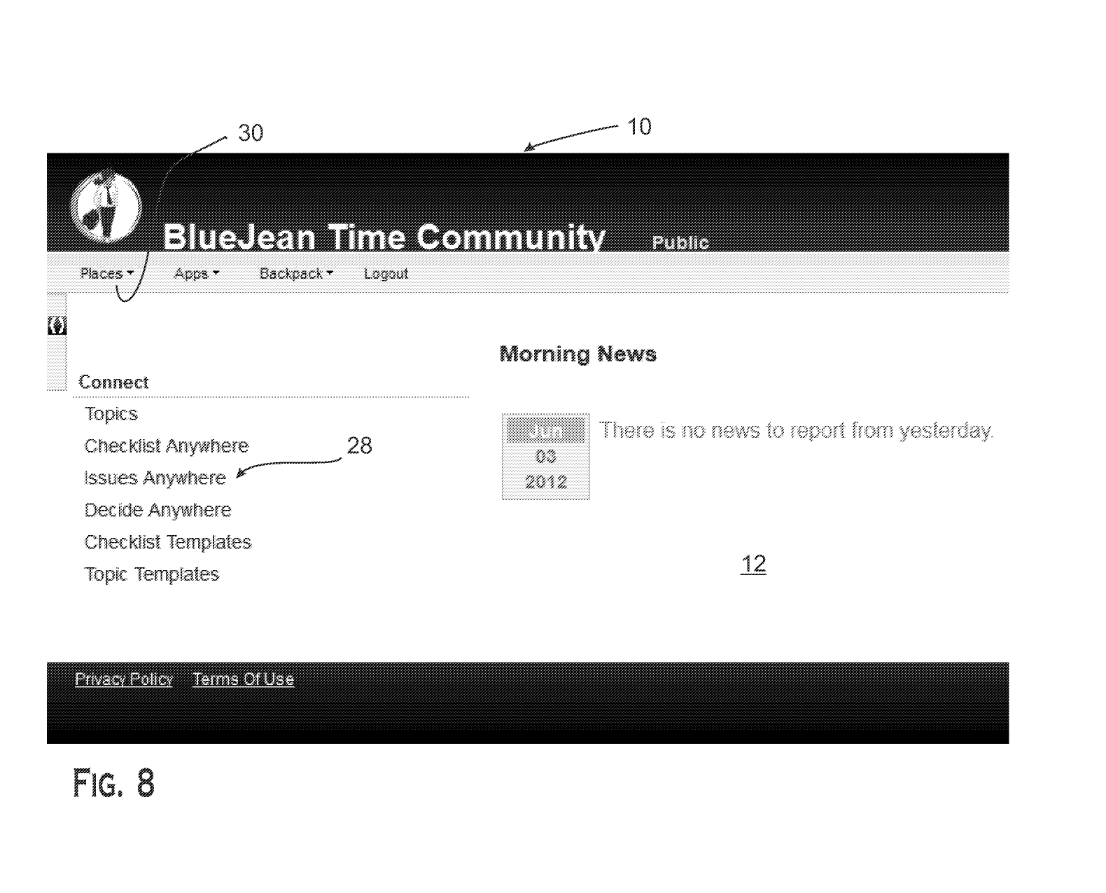

Referring to FIGS. 1-19, wherein like numerals indicate like elements throughout, a collaboration system 10 preferably has built into its design the ability to organize the work of parties/users that are preferably distributed (not geographically co-located) as well as to gather inputs on topics and other data in an ordered manner enabling informed decisions. It is also preferred that the collaboration system 10 (an interface for which is shown in FIG. 8) provides a number of application/collaboration tools that can be combined and/or organized by users to allow users to create custom functionality, user defined platforms, and/or user created templates. Additionally, via the use of tracking type of applications (like time/expense reporting, voting and balloting tracking, accounting/payroll/budgeting, and other ERP type of features), they will be able to leverage the power of multiple collaboration constructs that can be used to create custom solutions.

The combination of topics, voting, document and file attachments, and checklists enable a user to go from concept to product leveraging platform artifacts that enable them to monitor progress and make big and incremental decisions along the way. Template/filtering features preferably enable users to design new/unanticipated workflows without writing code. Furthermore, the internal application program interfaces (APIs) for create a topic tools, create a checklists tools, and voting tools enable users of the collaboration system 10 that are also developers to write business applications (“Apps” or collaboration tools) which leverage these features in their new applications so that planning, and decisions can occur anywhere in the platform of the collaboration system 10 as well as in any geographic location due to the preferably use of cloud technology with this system 10.

Accordingly the collaboration system 10 environment (which is experienced by users via one of many graphical user interfaces (GUIs)) 12 in defined virtual locations will change as the user navigates different areas, such as non-member areas, community member areas, work place areas, own biz place areas, and virtual places (also referred to as Places in the drawings and represent data ‘contained’ within one area of the collaboration system 10) owned by other companies for which the user may be a visitor, etc. The collaboration system preferably provides visual cues to inform the user of current location within the collaboration system 10. Those of skill in the art will appreciate from this disclosure that the GUIs illustrated are exemplary and that the present invention is not limited to any particular GUI or interface.

As more and more tracking type of applications (like time/expense reporting, accounting/payroll/budgeting, and other ERP type of features) are deployed in compliance with the collaboration system API, a user will preferably be able to leverage the power of collaboration constructs based on application/collaboration tools seamlessly.

Preferred Components for Implementing Collaboration System

The collaboration system 10 is preferably operable on one or more computer servers so as to be accessible by a user via a network. The collaboration system can be enabled by a set of instructions located on computer readable media configured to provide collaboration tools to multiple users via a network.

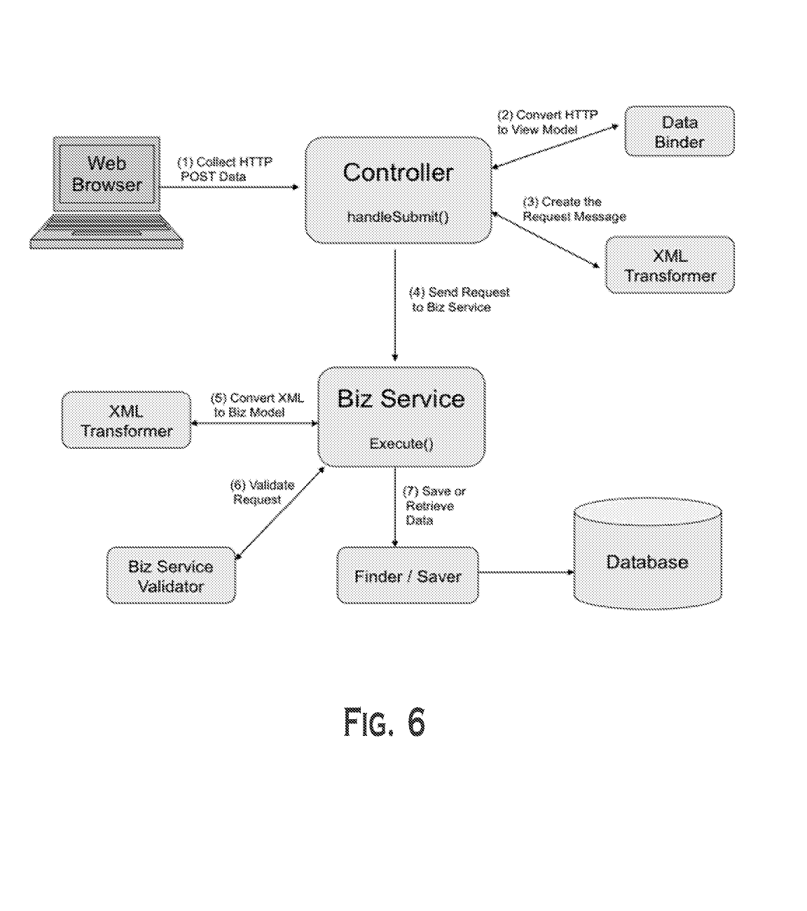

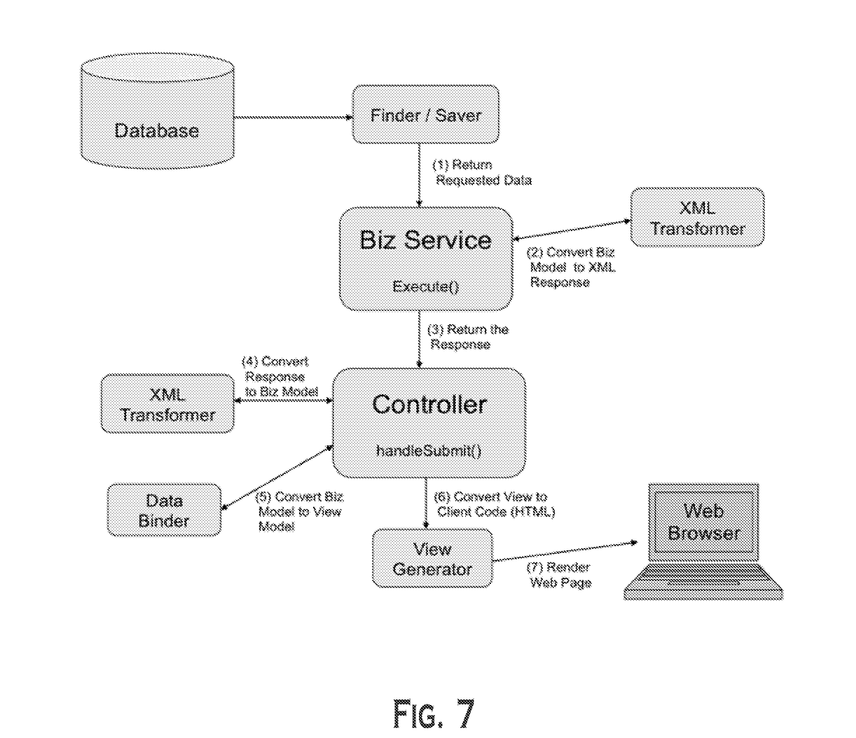

Referring to FIGS. 6 and 7, the preferably web or intranet accessible collaboration system 10 preferably includes several custom software components. In one embodiment, it is preferred that the application architecture is divided into multiple tiers: (1) the communications channel tier is the logical grouping of all code that provides the GUI 12. This includes HTML and JavaServer Pages (JSPs), Cascading Stylesheets (CSS), JavaScript, and java controllers (Struts-based); (2) the business services tier is the logical grouping of left-bar business service implementation code; (3) the persistence services tier is the logical grouping of code that enables the retrieval and storage of the collaboration system's cloud App data. The illustrated database may be located on a main server, on one or more servers, or separately accessible without departing from the scope of the present invention.

One preferred software component that can be used on all tiers of the application is the Spring Framework. This is an open-source COTS product that provides something commonly referred to as an Inversion of Control (IoC) container. The Spring container is a lightweight object lifecycle management framework. It's chief responsibilities are the creation, initialization, and configuration of the various Java objects used in every tier of the system. The Java objects that are managed by the Spring container can be called Beans, Spring Beans, or Managed Beans. In this document, those terms will be used synonymously.

The configuration, or “wiring up” of these objects is preferably done in Spring Bean Definition XML files. Some of the benefits of adopting the Spring framework are: (1) enables highly-configurable software interfaces and implementations; (2) all configuration can be done in XML files; (3) dependent objects (or beans) can be wired up in the XML files using the dependency injection pattern; and (4) ease of testing. Those of ordinary skill in the art will appreciate from this disclosure that although one preferred software architecture and particular programming languages and codes has been described above, any suitable software capable of implementing the collaboration system 10 of the present invention can be used without departing from the scope of the present invention.

FIG. 6 shows preferred typical software component interactions and workflow when a user is posting data to the collaboration system 10. FIG. 7 shows a preferred typical software component interactions when a user receives presented data from the collaboration system 10. Those of ordinary skill in the art will appreciate from this disclosure that any suitable software component interactions can be used by the collaboration system 10 of the present invention without departing from the scope of the present invention.

As mentioned in the section above, the architecture for this design is preferably a service oriented architecture which has been broken into three major layers: communication channel, business service and persistence. There preferably exists program code in each layer to enforce the data and logic flow described in conjunction with the collaboration system 10. All left bar services can be governed by this data/logic flow and the topics business service is simply a leftbar service as any other from an architectural perspective.

The database design subset relating to topics preferably take into account the specific schema that the persistence layer uses to create, update, and delete information related to the topic created by the create a topic collaboration tool. The schema component preferably enables the creation of topics and responses independent of the context is a document table. This is a complex concept where this table contains data, not just for topics but for many other web documents like email templates for invitations, survey questions/answers (which is how elections/decisions capability may be implemented etc.

Below are two tables, the first showing the structure of the Document Table, and the second showing the record content relevant for the Topic design.

Table Definition

table name - document
table purpose - store document data
table usage hints -
resultset mapping bean(s) -

| column name | type | description | comment |
|---|---|---|---|
| document_id | | | |
| document_type_id | | | |
| description | | | |
| data | | | |
| keyword_list | | | |
| reserved_key_1 | varchar(255) | | |
| reserved_key_2 | varchar(255) | | |
| reserved_key_3 | varchar(255) | | |
| reserved_key_4 | longtext | | |
| reserved_key_5 | longtext | | |
| reserved_key_6 | varchar(255) | | |
| start_date | | | |
| end_date | | | |
| created_by_id | | | |
| created_datetime | | | |
| updated_by_id | | | |
| updated_datetime | | | |
| customer_id | | | |

Forum Topics and Posts (Responses)
purpose—record that holds a specific Forum Topic or Response Post
usage hints—
leftbar story references—
resultset mapping bean(s)—

Associated Finders and updaters:
FinderForumTopicSingleWorklistltem & FinderForumTopicResponses;
UpdaterSaveGenericForumTopic & UpdaterSaveGenericForumTopicPost;
UpdaterSetParentTopicUpdateTime;
UpdaterAssociationByGivenAssocType & UpdaterEndAssociationByEntitiesAndTypeAndCustomerId;
UpdaterDeleteForumPost; UpdaterDeleteForumTopic & UpdaterDeleteTopicAssociations

| | | | | result bean |
|---|---|---|---|---|
| | | | result bean | Properties |
| table column | | | property name | key |
| name | view column name | description | mapping | mapping |
| document_id | | | | |
| document_type_id | | id# 401 = | | |
| | | ‘ForumTopic’; | | |
| | | id# 402 = | | |
| | | ‘ForumPost’ | | |
| name | name | | | |
| description | :subject | | :subject | |
| data | :body | | :body | |
| keyword_list | | | | |
| reserved_key_1 | :specificForumKind | ‘AppRequest’; | :specificForumKind | |
| | (for Topics only .null. | ‘EachOneTeachOne’; | | |
| | for Reponses) | ‘Forum’; | | |
| | | .null. (no longer | | |
| | | used) | | |
| reserved_key_2 | | | | |
| reserved_key_3 | | | | |
| reserved_key_4 | | | | |
| reserved_key_5 | | | | |
| reserved_key_6 | | | | |
| reserved_key_7 | | | | |
| start_date | startDate | | startDate | |
| end_date | endDate | | endDate | |
| created_by_id | | | | |
| created_datetime | | | | |
| updated_by_id | | | | |
| updated_datetime | | | | |
| customer_id | | | | |
| [symbol] | | | | |
| | will | | | |

[symbol]

indicates data missing or illegible when filed

Referring to FIG. 8, the collaboration system 10 presents a graphical user interface 12 to a user that represents the entire public community space on the collaboration system 10. This public community space allows a user to see all content on the collaboration system except for that which the user does not have the necessary permissions.

A user can create a virtual place on the system that is directed to a particular group of data which may be relevant to a group of users and/or projects. The virtual place is used to gather information and/or use customized application/collaboration tools and can have access limited to particular users. The virtual place represents a location that a user can visit where the user is given a visual cue that they are in a particular place within the collaboration system. It is also preferred that within a virtual place there is a collection of business services available where the access to the Place itself (administration of credentials or even the decision on whether credential is required), access to App business services (as with our current rights/roles construct) or data (visibility of subset of biz service worklist) may be defined by the place administrator who is preferably the user that created the virtual place.

Accordingly, within the public community, multiple virtual places can be established with different restrictions as to which users can access the virtual places. Within each virtual place grouped data which may incorporate data constructs such as multiple topics, checklists, voting, balloting, documents, putting tabulations can be established. Some application tools that are preferred for use with the collaborative system of the present invention are a topic creator, checklist creator, timelines, the bidding tool, and a voting tool. These application tools can be used together. For example a check list can include a voting tool to allow different users to vote on whether to proceed with the project or whether to proceed with one aspect of a project.

Throughout this specification multiple preferred methods of the present invention will be disclosed. It should be understood that the particular steps of each method can be performed in any order or some omitted without departing from the scope of the present invention. Additionally, any of the steps from one method may be combined with those of another without departing from the scope of the present invention.

Referring to FIG. 1, a preferred method of the present invention is disclosed. Referring to step A1, the collaboration system 10 may include a computer readable medium having stored thereon a plurality of instructions which, when executed by the process of a computer system cause the process to allow access to the collaboration system 10.

During step A2 a server is provided which includes a computer readable medium having a software module thereon configured to provide collaboration tools accessible by multiple users over a network. In step A3 a first data file on the server is configured to represent collaborative information in the form of at least one of a task, discussion topic, document, or the like for approval. The first data file is preferably created in response to user instructions.

During step A4 the software module is configured to receive instructions from at least one of the multiple users to transform the first data file to allow for votes to be collected and stored on the server in connection with the collaborative data in the first data file. The voting can be performed by sending a series of icons to a person, such as a happy face, a less happy face, a neutral face, a sad face, and a mad face and allowing recipients to provide corresponding feedback. Alternatively, a range of clickable values and their corresponding meanings can be sent to a person(s) to obtain feedback. In addition, voting can be done by combining agreement/disagreement with strength of feeling so that numerical values can be assigned to correlate the strength of agreement or disagreement. Multi tiered voting can also be used to help decide between multiple business opportunities so that people can vote for their top two or three opportunities and have replies weighted to come to a final opportunity to pursue. Those of ordinary skill in the art will appreciate from this disclosure that the present invention is not limited to the above described voting schemes but instead any suitable voting method can be incorporated with the collaboration system 10 without departing from the scope of the present invention.

In step A5, the software module is preferably configured to transform the first data file into a modified first data file which includes vote information wherein the multiple users submit data signals to the collaboration system 10 which represent votes via the network and the server stores the voting data in the modified first data file.

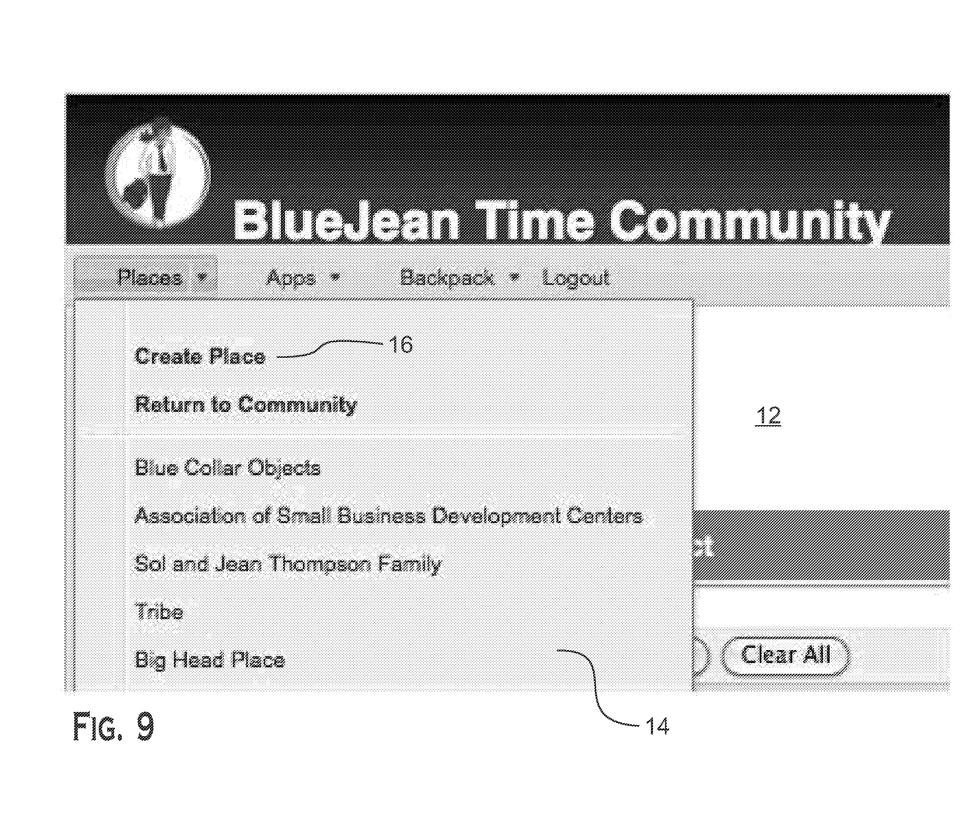

In accordance with one embodiment of the present invention, a server system can be provided which enables users to create a virtual space on a network. A portion of a preferred GUI menu 14 for creating a new virtual place is shown in FIG. 9. A link 16 can be placed on the menu for a user to instruct the collaboration system 10 to define a new virtual place.

The system architecture can be an exemplary server or client computer or like computer, on which a network access system can be implemented. The exemplary computer system is discussed only for descriptive purposes, however, and should not be considered a limitation of the invention. Although the description may refer to terms commonly used in describing particular computer systems, computer software languages, or the like the described concepts apply equally to other computer systems, including systems having architectures that are dissimilar that described elsewhere herein.

The server or client computer preferably includes a central processing unit, which may include a conventional microprocessor, random access memory for temporary storage of information, and read only memory for permanent storage of information. A memory controller can be provided for controlling system RAM. A bus controller may be provided for controlling the bus, and an interrupt controller can be used for receiving and processing various interrupt signals from the other system components.

A diskette, CD-ROM, or hard disk may provide mass storage. Data and software may be exchanged between client and server via removable media or a network. User input to the server computer may be provided by a number of devices. For example, a keyboard and a mouse may be connected to a bus by keyboard and mouse controllers. An audio transducer, which may act as both a microphone and a speaker, could be connected to the bus by an audio controller. Those or ordinary skill in the art will appreciate from this disclosure that in the art that other input devices, such as a pen and/or tablet and/or camera and a microphone for voice input, may be connected to server computer through a network or other communication means.

The network may be a local area network (LAN), a wide area network (WAN), or the Internet, and may utilize general-purpose communication lines that interconnect a plurality of network devices.

A web server may answer URL (Universal Resource Locator) requests by sending back pages of data encoded in HyperText Markup Language (HTML) or using any other suitable encoding. The web server may also handles URL requests and HTML forms that trigger executable programs. The Web server can include code that manages both inbound and outbound HTTP (HyperText Transfer Protocol) communications. In these respects, the Web server may perform like any other HTTP server, responding in the standard way to standard URL requests.

Those of ordinary skill in the art will appreciate from this disclosure that the term “collaboration tool”, as used in the claims and associated portions of the specification, means “a specific application tool configured for a particular use”. For example, if a checklist tool is used to create a checklist within a discussion thread and, separately, to create a second checklist then each checklist is preferably considered a separate collaboration tool. Accordingly, the application tools can be used to create multiple customized collaboration tools that are preferably accessed by a user via a network.

### Virtual Backpack

It is preferred that the collaboration system provides a virtual backpack (also referred to as a backpack in the drawings) that identifies and organizes received data and the particular collaboration tools that are associated with a user's identity such that the information is available to the user no matter what place the user it is currently visiting in the collaboration system.

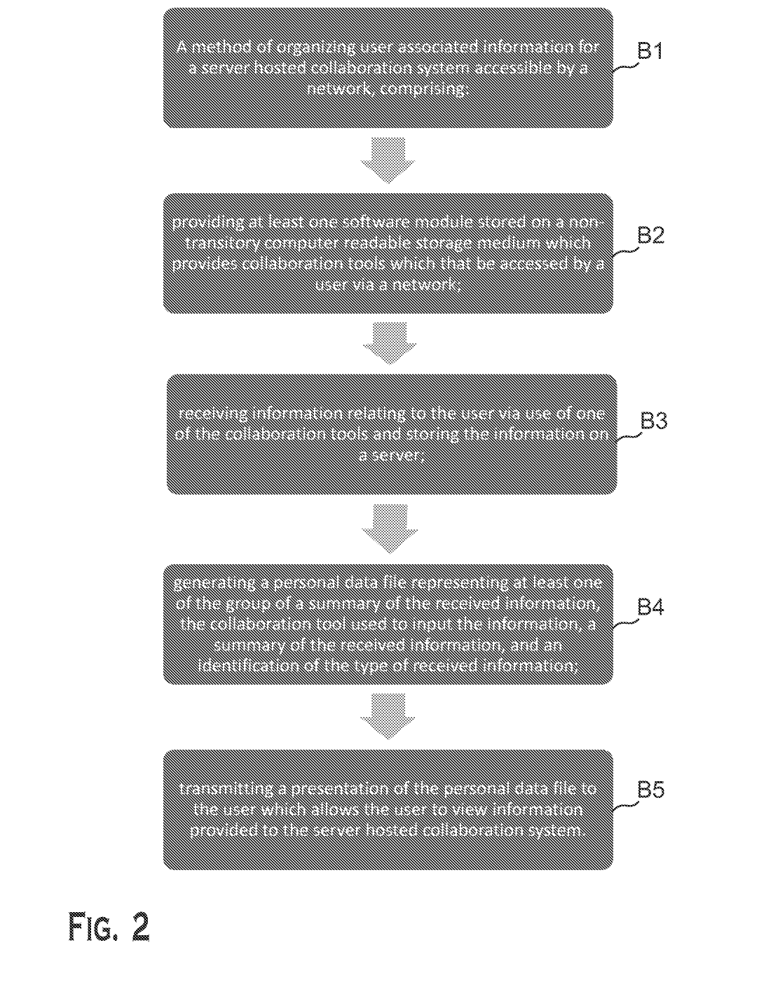

The virtual backpack may be implemented using the preferred method shown in FIG. 2. Step B1 is directed to a method of organizing user associated information for a server hosted collaboration system 10 accessible by a network.

During step B2, at least one software module stored on a non-transitory computer readable storage medium is provided which provides collaboration tools which can be accessed by a user via a network. In step B3, information relating to the user is received via use of one of the collaboration tools and the information is stored on the server or in temporary memory.

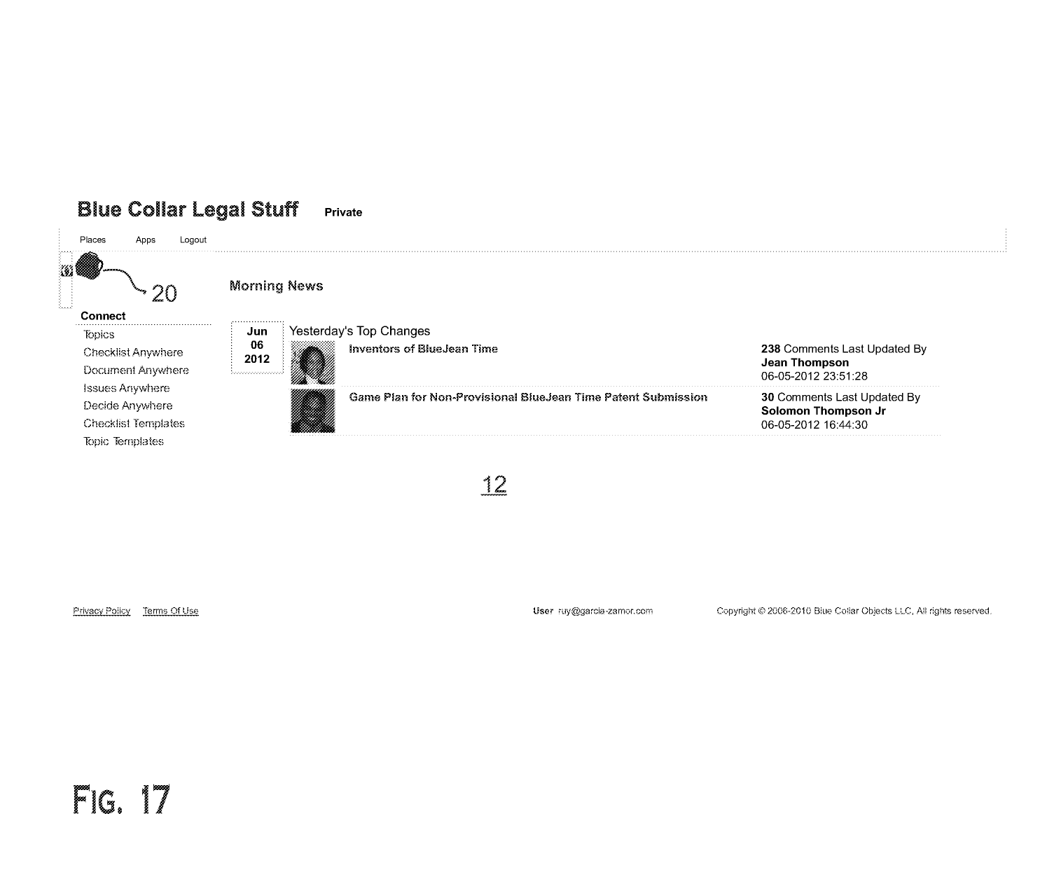

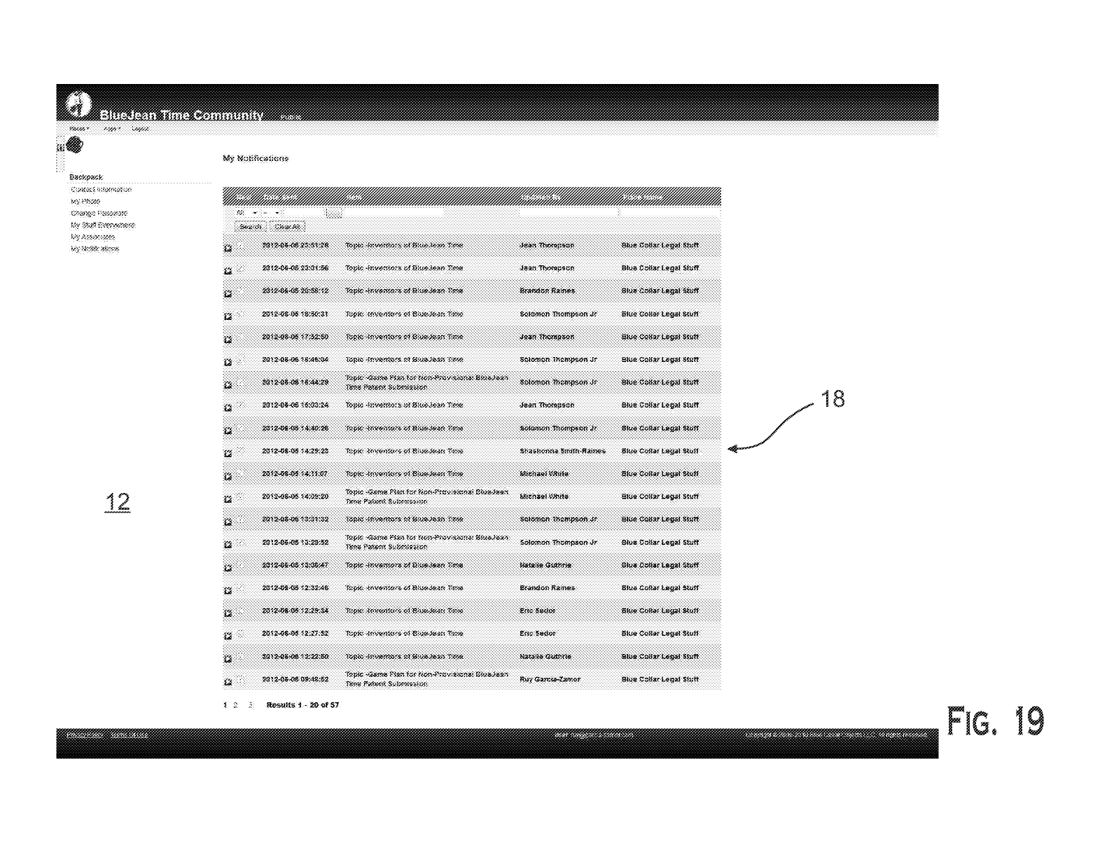

During step B4, a personal data file is generated that preferably represents at least one of the group of: (1) a summary of the received information, (2) the collaboration tool used to input the information, (3) a summary of the received information, (4) an identification of the type of received information; and (5) similar types of user data. Any other suitable category of personal information can be used without departing from the scope of the present invention. Referring to FIG. 17, the personal data file may be generated in response to receiving user instructions, such as by selecting the backpack icon 20 shown in the upper left corner of the GUI 12. Referring to FIG. 19, in step B5, a presentation 18 of the personal data file is transmitted to the user which allows the user to view information provided to the server hosted collaboration system.

Step B5 may, but does not necessarily, include the presentation 18 including information from separate virtual places regardless of a particular virtual place in which the user is currently interacting with the collaboration system. This allows a user to quickly look for all relevant data, tasks, queries, timelines, across the collaborative system regardless of the virtual place in which the user is interacting with the collaboration system 10. This allows for a user to receive tasks which are newly assigned in their virtual backpack for review and appropriate action.

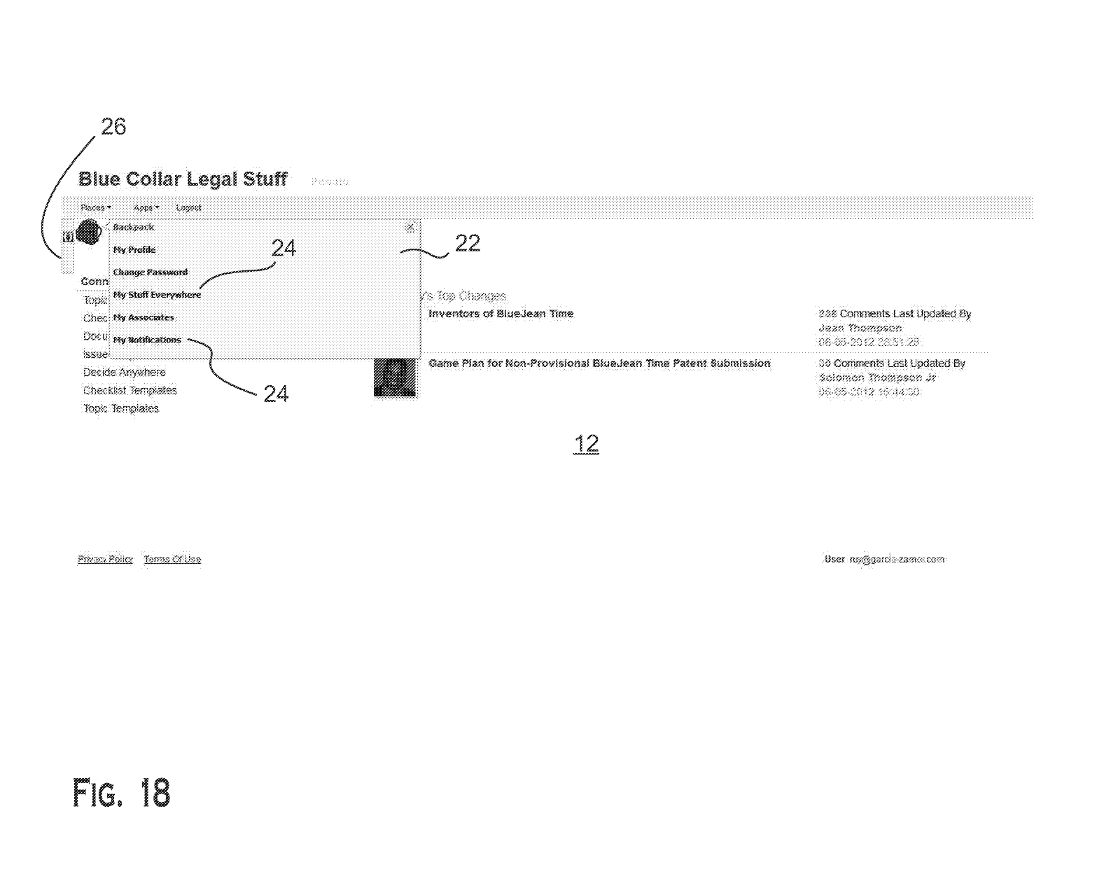

Referring to FIG. 18, this method may include modifying the presentation 18 to selectively view a subset of the personal data file. This can be done by selecting one of a number of filter selections 24 on the virtual backpack drop down menu 22 via the GUI 12. Referring to FIG. 19, the filtered personal data file presentation 18 was generated by selecting the filter selection 24 which corresponds to “My Notifications” (shown in FIG. 18).

It is preferred that step B5 include transmitting the generated personal data file to any one of a smart phone, tablet, reader, or similar device to allow access to the personal data file presentation 18 via the portable device. It is also preferred that the personal device is in communication with the collaboration system via the network to allow data to be input and modified on the server via the portable device. It is also preferable, but not necessary, that a user can modify specific user credentials for the collaboration system 10 via the personal device and transmit revised user credentials to the software module via the network. For example, while reviewing the personal data file presentation 18, a user may decide to give access to one of many created virtual places to another user to solicit input from that user.

Similarly, the virtual backpack can be implemented via a non-transitory computer-readable storage medium including at least some computer program code stored thereon. The storage medium being configured for access by a user and being adapted to allow a user to monitor user associated data received over a network. The computer readable storage medium may include computer program code stored on the non-transitory computer-readable storage medium configured to provide collaboration tools adapted to be accessed by the user. The computer program code may also be adapted to receive data from the user over the network. The received data could be input via one of the collaboration tools. The computer program code also preferably is configured to store the received data on a server and associating the received data with the user and with the one of the collaboration tools used to input the data.

It is preferable that the computer program code also operate on the server and to create a data file from the received data. The data file preferably represents a summary of all collaboration tools used to input data by the user. The computer program code may also be configured to transmit a presentation of the data file to the user which allows the user to see the summary of all collaboration tools which were used by the user to transmit data to the server.

Is preferred, but not necessary, that the summary also includes at least some information about the received data associated with all collaboration tools which were used by the user to transmit data to the user. It is further preferred that the summary is configured to allow a user to select any one of the listed collaboration tools and information about the received data so that the user is then taken to the associated collaboration tool within the collaboration system.

It is also preferred that a user is able to request different presentations of the data file, such as requesting to see: the user's profile, all information associated with the user, notifications for the user, a list of associates of the user, or other suitable category of information. As such, the virtual backpack allows a user to quickly personal information no matter where in the public community a user is currently interfacing with the collaboration software.

It is preferred that a user will have access to his or her virtual backpack in every place they visit in the collaboration system 10. It also preferably facilitates quick access to personal information and data contained in the virtual backpack via three or fewer mouse clicks.

Users should be able to set privacy settings for things in their virtual backpack while, owners of virtual places (like businesses, schools) should be able to also determine the visibility/privacy settings for info (company blogs/topics/financial info, etc.) housed in their environment via their virtual backpack which is preferably a presentation of at least part of an associated personal data file. The virtual backpack preferably incorporates a status capability where if the user's status is updated in the data files contained within the virtual backpack, then the updated information is transmitted to and updated in update in LinkedIn, Twitter, Facebook, or any other social site, and/or a related email, text message, or computer generated voice message may be sent regarding the update.

It is also preferred that the collaboration system 10 can install data files, associated software modules, applets and applications configured to interact with the collaboration system, engage in payment and/or money transfers, and/or user keys for accessing restricted system areas/virtual places/or files via user devices, such as desktops, laptops, smartphones, etc. This essentially allows the virtual backpack to also be used for credential management when interfacing with the collaboration system. For example, the data file and an associated software module or associated applet could be located on an iPhone as an application.

It is preferred that the data file presentation include user activated options, such as a “My Stuff Everywhere” filter selection 24 on a leftbar available within the virtual backpack drop down menu 22 on the iPhone which will enable users to quickly access tasks assigned to them from any virtual place within the collaboration system 10 and to send and receive notifications when comments are made to any of the tasks. This facilitates conversations between members of a team working on a checklist via the collaboration system 10. It is also preferred that the associated software module allow a user to update a user profile to include a photo, add biographical information, special skills, interests, privacy setting for profile information, etc.

It is preferred that the personal data file or an associated software module use a backpack icon 20 over which a number can appear that correlates to the number of pending items to be viewed, including alerts for overdue or soon to be due tasks, overdue checklists created by member etc. A message inbox for one-on-one or group conversations may also be available, such that the same information is available in both the browser and the iPhone or other smartphone.

### Shonnastick

Referring to FIG. 18, the collaboration system 10 preferably transforms data files to include checklists, or to be pushed to another user, or to be pulled to a user operating the system, via use of an icon bar 26 (also referred to as an Shonnastick). While users operating collaboration tools within a topic, place, issue, or decision, the user can send signals to the collaboration system via the icon bar to modify the data in the collaboration system. In addition to adding a checklist, pushing to human, pulling to self, and help to a Topic, Issue or Decision, there is preferably also the option of collapsing the icon bar (which is preferably displayed as a leftbar on the graphical user interface).

The Shonnastick can also be used to transmit and manipulate data files to facilitate processing signals representing a set of social/connecting/associating actions relevant to a context, and available based upon user and role. For example, within a Connect Application, the Shonnastick may enable any artifact to any artifact connections, voting and pushing and pulling notification for changes. For example, when the context is a Checklist Item, one could go to the Shonnastick both to setup an election (elector role) and the electorate (placemember role) can use it to vote. It can be used to associate an issue to a checklist item or a topic. The Shonnastick can also be adjusted by a user to include additional functions or incorporate additional applications if desired.

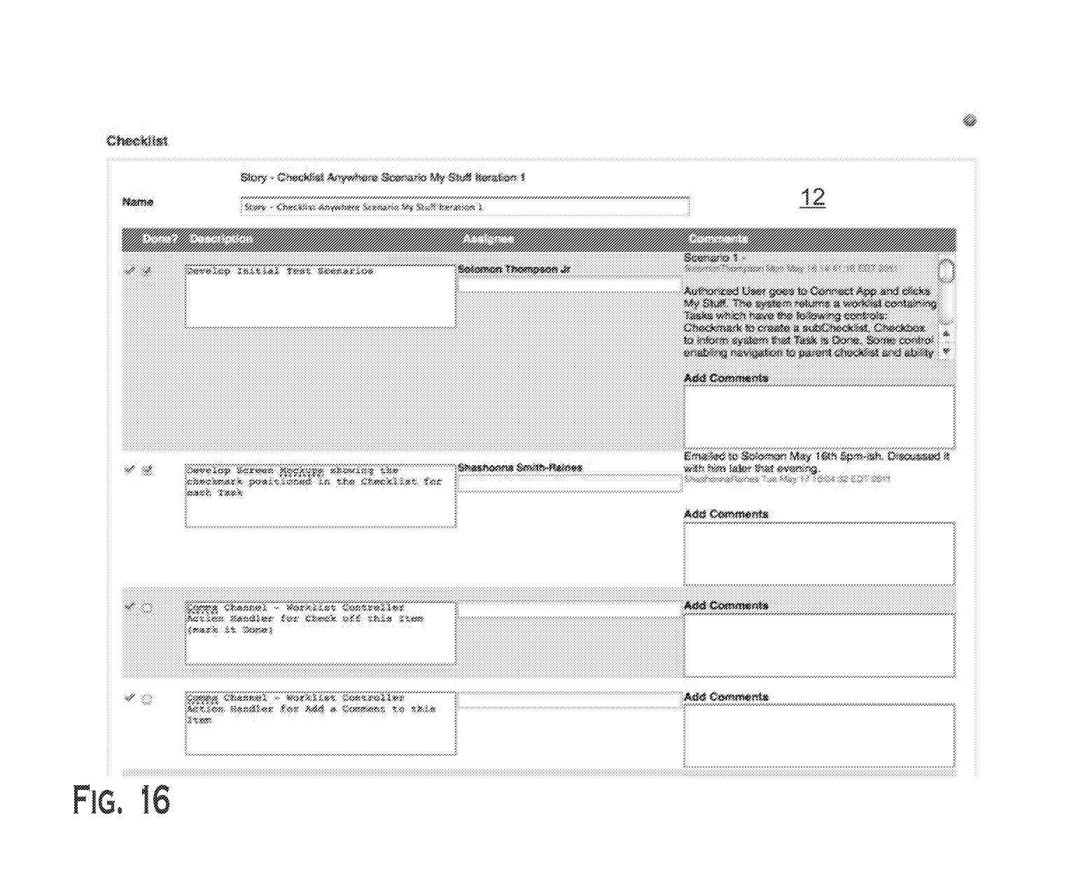

While it is preferred that checklists are added via the Shonnastick icon 26 which may be presented on any of the GUI 12 screens, those of ordinary skill in the art will appreciate from this disclosure that any suitable mechanism or control may be used to instruct the collaboration system 10 to either create a checklist or to modify an existing data construct to incorporate a checklist. One sample GUI showing a checklist is illustrated in FIG. 16.

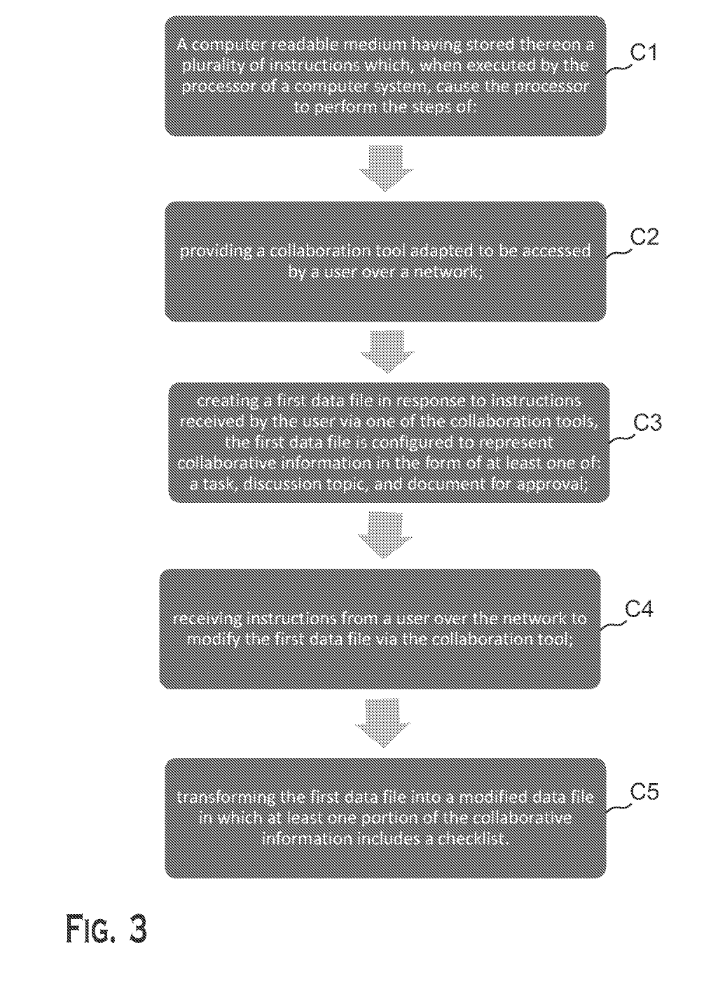

Referring to FIG. 3, one embodiment of the present invention includes, during step C1, preferably includes providing a computer readable medium having stored thereon a plurality of instructions which, when executed by the processor of a computer system, cause the processor to perform the steps of the method. During step C2, a collaboration tool is provided which is adapted to be accessed by a user over a network. In step C3, a first data file is created in response to instructions (computer data signals) received from the user via one of the collaboration tools. The first data file is configured to represent collaborative information in the form of at least one of: a task, discussion topic, and document for approval.

In step C4, instructions are received from a user over the network to modify the first data file via the collaboration tool (which in some cases be transmitted via the Shonnastick icon 26). During step C5, the first data file can be transformed into a modified data file in which at least one portion of the collaborative information includes a checklist.

15. It is preferred, but not necessary, not necessary, that step C2 include providing the collaboration tool to the user via an icon bar 26 (also referred to as the Shonnastick) located on a graphical user interface 12.

Moreover, if a user is in any other application (also referred to as an “App” within the collaboration system 10), say a budgeting App, one could use the Shonnastick to associate a checklist or another data set—such as a issue to the go screen or GUI 12 showing the budget, a checklist to resolve the issue, and/or a vote on what the dollar value of the budget for an item should be.

The collaboration system 10 can be designed so that App developers would get to use the Shonnastick icon 26 for free because it would be available due to the schema design and the already existing connect App biz services being able to be invoked in any leftbar context 28 (see FIG. 8) powered by the Shonnastick.

### Updated App Store Purchasing

The collaboration system 10 preferably includes flexible application purchasing. For example, a user may purchase an App that instead of being purchased/subscribed to for just one virtual place, is available in any virtual place created by the user within the collaboration system 10. The collaboration system may also sell Apps on a one-time sale price basis with the reseller receiving a percentage of the sales price based upon a purchaser purchasing a product from within their (place created by the member) place. For example, if a user purchases a particular app to use in a place they have created and a second user decides to purchase the use of the App from within the place created by the first user, then the first user may receive a percentage of sales price, such as ten percent (10%) or any other suitable amount.

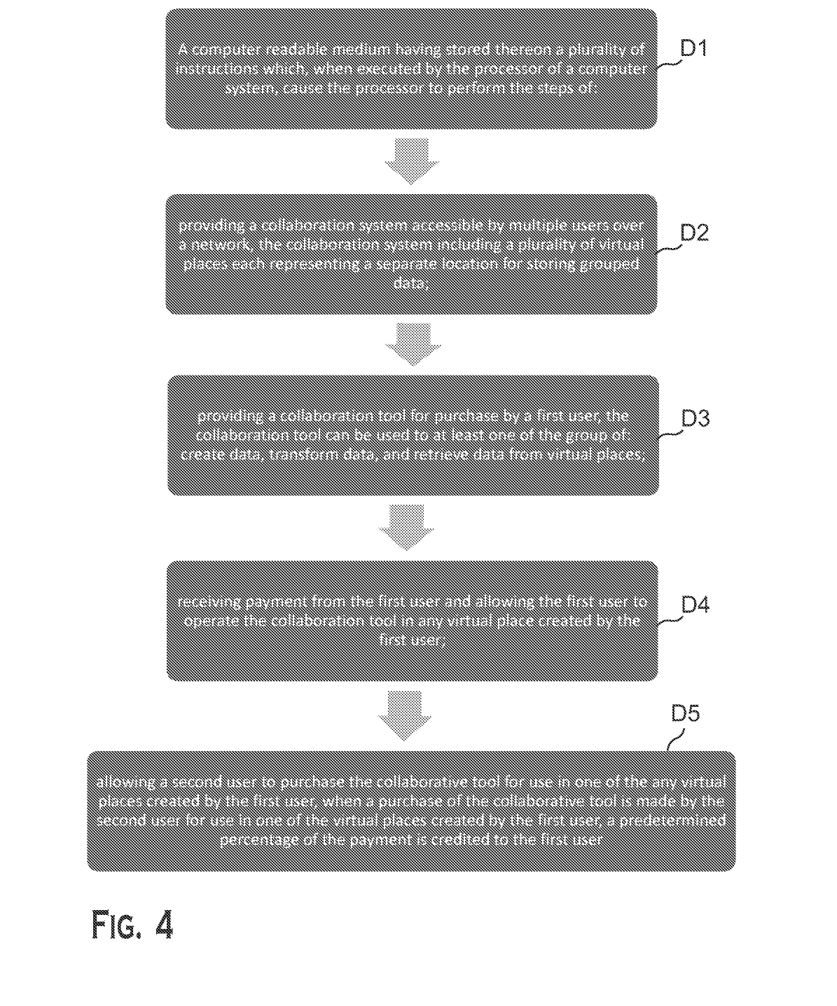

Referring to FIG. 4, a preferred method according to the present invention is illustrated. In step D1, a computer readable medium is provided. The computer readable medium has stored thereon a plurality of instructions which, when executed by the processor of a computer system, cause the processor to perform the steps of the method. During step D2, a collaboration system is provided which is accessible by multiple users over a network. The collaboration system 10 preferably includes a plurality of virtual places each representing a separate location for storing data (which data may be grouped by user or project, etc.).

In step D3 a collaboration tool is provided for purchase by a first user. The collaboration tool can be used to at least one of the group of: create data, transform data, and retrieve data from one or more virtual places or from temporary memory. During step D4, payment may be received from the first user and the first user may be allowed to operate the collaboration tool in any virtual place created by the first user. Alternatively, the first user may only be authorized to use the collaboration tool within a particular virtual place.

In step D5, a second user may be allowed to purchase the collaborative tool for use in one of the any virtual places created by the first user. When a purchase of the collaborative tool is made by the second user for use in one of the virtual places created by the first user, a predetermined percentage of the payment is preferably credited to the first user.

In another embodiment, application and/or collaboration tool purchasing can also use another revenue sharing mechanism. For example, users can be compensated for purchases made as a result of the user referring or recommending a collaboration tool or application to others. The term “application” as used herein to discuss items/artifacts/software modules/apps/applets/tools that can be purchased is defined as meaning “any one or more of an application, a collaboration tool, a program module, or the like.” For example an application can be a collaboration module such as a time keeper for a group of attorneys or a personal application such as a weight tracker without departing from the scope of the present invention. In the claims it is possible that both a collaboration tool(s) and an application(s) is recited. This is not contradictory when the revenue sharing is performed on a collaboration system. When this is the case, the recitation of at least one collaboration tool makes it clear that there is at least one such tool for purposes of further defining the function of the collaboration system. When application is recited afterwards within the same claim it is intended that it can refer to one of the already recited collaboration tools or to a separate application which may not necessarily normally be classified as a collaboration tool, for example a personal best time for tracking race times. While it is preferred that the revenue sharing is used in conjunction with the collaboration system, those of ordinary skill in the art will appreciate from this disclosure that the revenue sharing function can be used in other contexts without departing from the scope of the present invention.

One method of compensating users for referrals is compensating users for purchases that result from the user sharing information about the application. Sharing is preferably accomplished by the user selecting to share information about an application by selecting a share button on the GUI or otherwise activating a share function. It is preferred that the share button include the fictitious word “Share” in which the “S” that normally begins the word “Share” is replaced with a “5” to become “Share”. This fictitious word is preferably incorporated into part of a revenue share button/icon/link which enables the selector of the button to share in revenues collected for the application if the purchaser executes the purchase by clicking the link they received from the user.

The link that is generated by a user when selecting the share button, or other mechanism, can preferably be sent through email, Facebook, Twitter, or any other type of social network account or electronic transmission of data. While it is preferable that the shared data is sent as a link, any suitable type of communication can be used, such as sending an image with an activation or offer code or the like located thereon. It is preferable that embedded in the link or associated with the offer code is information identifying the user that shared the information so that the collaboration system can automatically credit the shared revenue to the user. Links can be auto destructing so they cannot be re forwarded by shared information recipients if the function is set by the collaboration system.

Depending on the settings in place at the time of the shared information, the payment percentage to the referring user can vary but is preferably about ten percent. Additionally, the collaboration system can provide a smaller revenue share to the original recommender for purchases resulting from a sale resulting from sharing of the information by a purchaser that made their initial purchase based on a first share by the user. For example, please review the following situation. User one refers an application to user two via the share functionality and user two purchases the application. As a result, user one may now be entitled to receive a percentage of the revenue generated by the purchase by user two. For example, it can be assumed that the percentage is ten percent. User two then shares information about the same application with user three via the share functionality and user three purchases the same application. As a result, user two may now be entitled to receive a percentage of the revenue generated by the purchase by user three. For example, it can be assumed that the percentage is ten percent. Additionally, user one may now be entitled to receive a percentage of the revenue generated by the purchase by user three. For example, it can be assumed that the percentage is two percent. The collaboration system may be set to use continually diminishing amounts of shared revenue depending on how many links in the referral chain exist. For example, the system my provide a ten percent share for a purchase based on a direct share, two percent for a once forwarded share, and one percent for a second forwarded share.

The collaboration system also provides for modifiers to the shared revenue amount. For example, if an application developer successfully refers an application then an increased percentage of the shared revenue in addition to any other compensation plan can be provided. Furthermore, the collaboration system allows users that share information to select different settings for how the information is shared above and beyond sending links or other communications. For example, if a user includes a personal comment on their experience with the application and why they are recommending it, then a higher percentage of shared revenue may be paid. The collaboration system preferably receives copies of all shares and scans personal comments for authenticity. This scan can include comparing the application being referred to: recorded use by the user sharing information and/or comparing multiple reviews provided by the user to see if non relevant, canned, generic, or recycled language is being used. The collaboration system can automatically deny the enhanced percentage of shared revenue if a problem is detected, place a hold on the revenue share, alert a supervisor, and/or send an automatic message to a designated person to review the matter.

Purchasing of the application by a recipient of the link could be on a one-time fee basis or on an ongoing subscription fee basis. Either way, the user that shared the information about the application would preferably be entitled to the percentage published and visible as part of the “Sharing” workflow.

When using an application a new GUI can be generated for setting related to the application. When viewing the collaboration tool GUI it is preferable that a share button/icon will be visible within the GUI. Placement can vary based on the discretion of the application developer/designer working with the collaboration system administrators/automated submission software/developers/designers. The revenue share button/icon will also preferably be available in the collaboration system application store anywhere an application is listed.

It is preferable that any current member/user of the collaboration system, when logged in, will have access to a share button/icon for applications offered by the collaboration system. The revenue sharing process preferably starts when the user clicks the share button/icon which is associated with a particular application. The user may be given options for sharing a purchase link to a target audience (could be one or more potential purchasers) via any suitable notification distribution mechanism like email, text, facebook, twitter or any other approach enabling the transmission of the product purchase link info and the members credentials. Depending on the collaboration system settings at the time, sharing of information regarding an application may require that the sharing user have already purchased the application, have used the application a particular number of times, or may require a similar parameter prior to forwarding the share information. Alternatively, the collaboration system can be configured to allow sharing of information regarding applications by users that have never purchased or used the particular application be referred.

When a purchaser clicks the resultant link received from the sharing by another user or received via another information such as an offer code, the purchaser may be taken to the collaboration system store's “Social Shopping Cart” where the product can be purchased. If the purchaser follows through on the purchase, the user who “Shared” the product with the purchaser will preferably receive a notification (optionally) of this transaction and have their collaboration system account updated so that they can receive the appropriate percentage of revenue collected by the collaboration system over the purchase lifecycle of the application. The specifics of the timing of payment or credit to the member's account may be at the discretion of the store operator.

### Charging for Virtual Place Membership/Access

An app is preferably provided which allows a user that owns a virtual place to readily set up the virtual place to charge other users for access. This particular app for charging for access to data within a virtual place is preferably referred to as the “dollar place” application and may be represented by the words “dollar place” or a logo. The dollar place application allows a user to almost instantaneously begin to monetize a virtual place. Additionally, the dollar place application may incorporate revenue distribution characteristics similar to that described above in connection with the share button functionality.

The dollar place application preferably allows a user that owns a virtual place and who purchased the dollar place application to by entering a few simple parameters change their own virtual place into a virtual place that charges other users for access. As such, the dollar place application makes it simple for a user to charge a price for membership to their own virtual place. This can be used by blogs that are already successful and wish to now charge for access. A blogger can simply establish a virtual place, purchase the dollar place application, and select the price of membership for access to the blog maintained within the virtual place. Then, most of the information technology complexities involved with establishing a paid group page/paid virtual place page are automatically taking care of by the dollar place application so that the user who owns the virtual place does not have to get involved with the proper selection, integration, and configuration of technology solutions for accepting payments, establishing checkout carts, processing credit cards, maintaining records for reporting, and properly distributing revenue is necessary between the user, the network, and possibly a sharer who referred the site in a manner as described above. This enables any user to set up any number of places and charge fees for entry to the virtual places. This greatly facilitates a layperson's ability to set up a paid group website without having to worry about the complexities of handling monetary transactions, IRS reporting, and software integration. Additionally, it is preferred that reports in connection with payments processed can be viewed in the user's backpack (alternatively also referred to as the user's backpocket).

For example, the user that wishes to raise funds for charity could establish a virtual place which maintains a list of guests for dinner and a schedule of the dinner's entertainment. Additionally, the virtual place could explain the percentage of the membership fees that will be donated to charity. If a user wishes to contribute to the charity then the user can pay the access fee to enter the virtual place created by a first user that owns the virtual place. Upon gaining access, the other user can add their name to the attendee list, peruse the schedule of events, or indicate that the maximum amount of proceeds should be donated to charity.

In one preferred embodiment, when a payment is made to the first user from another user, the dollar place application receives the payment, and credits approximately 70% to the owner of the virtual place using the dollar place application and approximately 30% of the payment to the owner of the collaboration system or network. When the dollar place application uses functionality similar to the above described share features for referrals, the site owner for the virtual place using the dollar place application would preferably, but not necessarily, receive approximately 60% of the payment, the owner of the collaboration system or network would receive approximately 30% of the payment, and the other user that referred the particular virtual place for which access is paid to a third party would receive approximately 10% of the payment. The above percentages used to describe the crediting of portions of the payment between parties are exemplary only. Those of ordinary skill in the art will appreciate from this disclosure that any percentage division of the payment can be used without departing from the scope of the present invention.

The dollar place application provides a mechanism for a user of the collaboration system to quickly and easily monetize a virtual place. This brings heretofore unheard of access to quick setup of a pay for membership or pay for access site to users of the collaboration system.

One preferred embodiment of the dollar place application includes a method of automating aspects of charging and receiving payments in exchange for access to a user's content on a collaboration system. The collaboration system is preferably configured for use on a server accessible by a network such that paid access can be readily established without requiring the independent integration of payment receipt and tracking software by the user and without requiring the user to select and determine software compatibility of the same for use on the server in conjunction with the virtual place.

The method preferably includes the step of providing at least one software module stored on a non-transitory computer readable storage medium which provides collaboration tools which can be accessed by the user via the network. The collaboration system may provide a plurality of virtual places each of which may be configured to require different credentials for access and each may have an individual or partially personalized graphical user interface associated therewith. Each virtual place may be originally created by a first user who can one of invite and allow other users to enter the virtual place on the network to access data stored therein and/or use any of the collaborative tools available within the virtual place. The term “first user” as used in the claims and in the corresponding portions of the specification, means “the user that originally created the virtual place and who, due to being the creator, is also the owner of the virtual place”. The extent to which other users can use the collaborative tools may depend on the settings of the virtual place set by the first user. Additionally, some virtual places may be created by the collaboration system operator for general use by all users as opposed to by a particular individual user of the collaboration system.

The method preferably includes the step of the network providing a collaboration tool to the first user which allows the first user to set payment terms for access by other users to the virtual place created by the first user. This can allow the first user to by selecting a single collaborative tool modify the virtual place so that the virtual place charges for access without the first user having to separately and independently identify and select appropriate software for virtual shopping carts, merchant services, and payment tracking, or the like. This allows the first user to by using a single collaborative tool change the virtual place to then require payment for access to the virtual place.

The method may include the step of the network automatically monitoring the payment terms and allowed access to the virtual place for which the dollar place application is purchased. Then, the dollar place application is preferably, but not necessarily, configured to readily receive and track payments from other users who wish to pay and receive access to the virtual place owned by the first user. As mentioned above, the payments received may be tracked, credited between different parties, and records kept for future reporting.

The method preferably includes allowing the first user to set payment terms for access to the virtual place by other users such that the dollar place application automatically credits a portion of received payments to the first user and another portion of the received payments to an owner of the network. This method preferably allows the first user to change the virtual place automatically without having to arrange for compatible technology for integrating payment processing and reporting. This results in allowing other users to quickly begin to monetize a virtual place (or group) or to start a new business with very little effort required on the information technology systems and programs necessary to launch such a business.

The method may include the dollar place application automatically tracking purchases resulting from the sharing of information by other users and crediting a portion of the revenue from the purchases to the one of the other users that generated the sale. The method preferably includes allowing other users to share information regarding the virtual place via electronic communication containing information identifying the identity of the other user generating the electronic communication. The electronic communication may be in the form of a link embedded in an email which can be selected by a recipient of the email. The at least one software module preferably, but not necessarily, automatically detects when the link is selected. Alternatively, the electronic communication may be in the form of a link embedded in a blog which can be selected by a reader of the blog. The at least one software module preferably automatically detecting when the link is selected.

The method may include allowing other users who are not an owner of the virtual place to send information about the virtual place to another via an electronic communication. The above mentioned examples of electronic communications is not all-inclusive. Those of ordinary skill in the art will appreciate that any suitable electronic communication can be used with the method of the present invention. For example, a pre-recorded audio message or image message can be transmitted by other users to refer third parties to the virtual place owned by the first user. The method may include automatic monitoring by the network as to whether the another person purchases access to the virtual place owned by the first user for which information was shared by the other users. Additionally, the method may include automatic tracking by the network of purchases resulting from the sharing of information by the other users and crediting a portion of the revenue from the purchases to the one of the other users that generated the sale as a result of the electronic communication generated prior to the sale.

One description of an embodiment of the dollar place application is as follows. The dollar place application is directed to automating aspects of charging and receiving payments in exchange for access to a user's content on a collaboration system configured for use on a server. The network provides the dollar place application tool to the first user which allows the first user to set payment terms for access by other users to the virtual place created by the first user. This allows the first user to by selecting a single dollar place application tool to modify the virtual place so that the virtual place charges for access. This allows the first user to by using a single collaborative tool change the virtual place to then require payment for access to the virtual place. The network then preferably automatically monitors the payment terms and allowed access to the virtual place and is configured to readily receive and track payments from other users who wish to pay and receive access to the virtual place owned by the first user.

### Apps and Virtual Backpack

A user (also referred to as a “Community Member”) can preferably also look in his/her virtual backpack to see list of all the Apps they've subscribed to (as well as all of the virtual places they've created and/or are invited to). Is also preferred that a community member should be able to see a list of all the purchases for which they are entitled to a reseller fee (preferably via a report on what is owed to the user and itemizing what has already been paid).

### Smart Phones/Tablets and Collaboration System App

It is preferred that a personal media device (such as an iPhone, iPad, tablet, reader or other portable computing device) will require only a single App to interface with the collaboration system 10 (this single application may be referred to as the “BlueJean Time App”). It is preferred that, within the BlueJean Time App, the user will be able to navigate any social leftbars made available without needing to make purchases. It is preferred but not necessary that the App will incorporate the backpack icon 20 as the portal for all data communications with the collaboration system 10.

### Credential Management within the Collaboration System

It is preferred that the user's credentials are organized based on the user's community identity which includes credentials for the user to log into the collaboration systems public community space. This credential is preferably assigned during registration of the user to the collaboration system 10. It is further preferred that every registered user of the collaboration system 10 is also a member of the BlueJean Time community (which is essentially another virtual place that is preferably public within the collaboration system 10).

If thereafter a user creates a virtual place, they are preferably automatically given appropriate roles giving them supervisory Powers in that virtual place/place/data location/server location. Additionally, this new virtual place preferably shows up on their place menu (see FIG. 8). It is preferred that a virtual place creator will be able to see a list of all of the virtual places which they have created. A supervisory user may invite other BlueJean Time Community members to the virtual place they are in using an add member capability.

It is preferred that whenever a user is added to (i.e., provided with permissions to enter or join) an existing virtual place and then creates a virtual place therein that they are given access to the new virtual place unless the access to the original virtual place to which the user was added is turned off by a supervisory user for that virtual place.

As an authorized member of a virtual place, a virtual place user should have access to place artifacts (data constructs or data files) as governed by the role they've been assigned within that place (and the associated rights for that role within the place). An authorized member of a virtual place should be able to navigate to any artifact within that place that they are authorized to access either by navigating to the place, to the correct leftbar and to the correct artifact or, directly by simply using the link. If the user is employing the latter approach (the link) and not logged in, after providing their community credentials at the challenge prompt, the system should take them to the artifact associated with the URL used.

It is preferable that a user will fill out the information required for registration if not already a community member. If a community member already, the user may log into the community, if not already logged on and could be presented with a challenge with the user id already filled in. The user can then fill in the password and preferably be forced to change the password. If the user was already logged into the community, they could receive the invitation from a community notification alert approach and when responding, the challenge for the place may have a user id filled in and they can go through same password change approach.

Upon successful login, the list of virtual places displayed in the GUI 12 is preferably updated and the user's key ring (electronic access rights) gets the virtual place credential added (so when logging into a Place the User ID will be pre-filled). Also, when shopping in store within the collaboration system 10, the store can leverage the keyring to determine on who's behalf the user can shop for. Some, but not all, options are: (1) their own if shopping for their virtual backpack; or (2) a virtual place, if they have authority to shop on behalf of that virtual place. It is preferred, but not necessary, that purchased products within a virtual place should all be able to leverage existing collaboration system services (eg. my invitations, linking to blogs/topics, etc.).

### Groups

Access control to invitations, blogs, topics, activities, etc within the collaboration system 10 may be facilitated using groups. The platform will provide some pre-defined Groups (community, virtual place, world) and virtual places and individuals will preferably have the power to define additional groups.

### Places

A user can preferably create virtual place independent of buying an App. In some embodiments, the collaboration system 10 can be configured so that all places can come preloaded with timekeeper and other Apps as a starter set, which may be free of charge. Starter kits may be varied depending upon the project for which the virtual place is oriented.

### Customized Places for Established or Individualized Entities

The collaboration system 10 preferably allows for the customization of virtual places to allow for personalized branding to generate a custom look and feel. For example, Bank of America, could create a virtual place within the collaboration system 10 where a user could selectively activate a control to obtain their financial information via a non-standard collaboration system 10 format or interface. This would allow for the creation of customized virtual places while still allowing community members/users to quickly revert back to an alternative location in the community. Similarly, customized Apps may be provided to facilitate user interface with customized virtual places.

### Customized Workflows

The collaboration system 10 provides users the opportunity to develop customized workflows incorporating highly sophisticated collaboration tools. By allowing users to selectively integrate application tools, a user can develop highly complex workflows without having to prepare significant program code. This allows users to create new collaboration tools built using established application tools and Apps as building blocks. This provides flexibility for users to create workflows that address particular desires or requirements.

For example, a user may have the ability to define a checklist within the context of a topic or other App Contexts. Additionally, a user can have the ability to assign Tasks to assignees and have those Tasks show up in the My Stuff feature for a virtual Place or in the user's virtual backpack.

It is preferred that a user has the ability to view Tasks assigned to them in any virtual Place where they are an authorized Member show up in the My Stuff functionality of their virtual Backpack. It is also preferred that a user has the ability to set up Elections and run Elections (voting) within the context of a Topics and Tasks as well as providing App Developers an Application Programming Interface (API) to enable these collaboration capabilities to be embedded in unanticipated contexts.

Furthermore, it is also preferred that users have the ability to define Templates and Enforce Naming Conventions (through template definition) to provide a non-technical user the power to define many simple collaboration application workflows (eg, Opportunity Management, Requirement Management, Defect Management, Planning Activities . . . ).

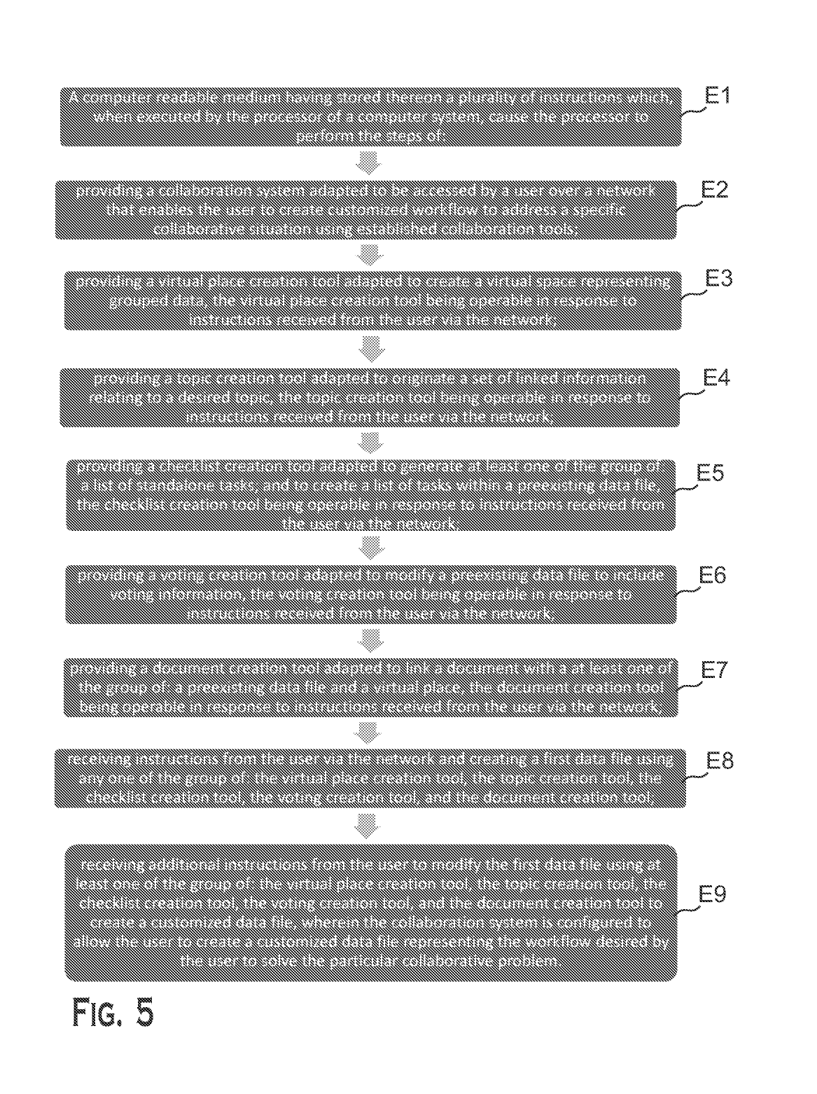

Referring to FIG. 5, one preferred method of the present invention, in step E1, provides a computer readable medium having stored thereon a plurality of instructions which, when executed by the processor of a computer system, cause the processor to perform the steps of this method. During step E2, a collaboration system 10 is provided which is adapted to be accessed by a user over a network that enables the user to create customized workflow to address a specific collaborative situation using established collaboration tools.

In step E3, a virtual place creation tool is provided which is adapted to create a virtual space representing data (grouped or otherwise). The virtual place creation tool is operable in response to instructions received from the user via the network. During step E4, a topic creation tool is provided which is adapted to originate a set of linked information relating to a desired topic. The topic creation tool is operable in response to instructions received from the user via the network.

During step E5, a checklist creation tool is provided which is adapted to generate at least one of the group of: (1) a list of standalone tasks; and (2) to create a list of tasks within a preexisting data file. The checklist creation tool is operable in response to instructions received from the user via the network. In step E6, a voting creation tool is provided which is adapted to modify a preexisting data file to include voting information. The voting creation tool being is operable in response to instructions received from the user via the network.

During step E7, a document creation tool is provided which is adapted to link a document with a at least one of the group of: (1) a preexisting data file and (2) a virtual place. The document creation tool is operable in response to instructions received from the user via the network.

In step E8, instructions are received from the user via the network and a first data file is created using any one of the group of: (1) the virtual place creation tool, (2) the topic creation tool, (3) the checklist creation tool, (4) the voting creation tool, (5) the document creation tool; and (6) any other suitable tool. During step D9, additional instructions are received from the user to modify/transform the first data file using at least one of the group of: (1) the virtual place creation tool, (2) the topic creation tool, (3) the checklist creation tool, (4) the voting creation tool, (5) the document creation tool; and (6) any other suitable tool to create a customized data file. The collaboration system is configured to allow the user to create a customized data file representing the workflow desired by the user to solve the particular collaborative problem.

Step E9 may include the modified data file including a checklist incorporating voting on at least one task therein. Furthermore, step E9 may also include receiving voting information from multiple users via the network that is incorporated into the modified data file.

Alternatively, step E9 may include the modified data file including a document incorporating voting for approval thereof therein. Furthermore, step E9 may also include receiving voting information from multiple users via the network that is incorporated into the modified data file.

Alternatively still, step E9 may include the modified data file including a topic incorporating voting for approval thereof therein. Furthermore, step E9 may also include receiving voting information from multiple users via the network that is incorporated into the modified data file.

### Examples of Different Embodiments of the Collaboration System

For example, a non-technical end user could be a business owner who, while a user of popular social networking applications or the owner/user of a mobile smart phone and some of their Apps, does not have an information technology (IT) background. This person may run a small business or organization, or maybe the leader of some project team. The empowerment capability of the collaboration system 10 will allow such a user to create customized workflows and to coordinate the activities of more than one individual (i.e., a team or organization), where the parties may be virtual (not situated in a face to face environment).

In typical business or other organizational constructs, the need for automation of workflows is achieved through the use of business applications. These business applications usually operate in the context of some IT infrastructure where the application functionality is housed in a collection of one or more servers and made available to client devices (laptops, desktops, mobile phones etc) through the use of common technologies. Typically, a non-technical end user would need IT support to do some subset of the following: (1) choose and setup the hardware, operating systems, Apps; (2) configure access control for users; (3) make sure that IT infrastructure is upgraded as appropriate; (3) provide advice as the organization changes and/or grows and needs new types of business automation or workflows; and (4) provide help desk support when things go wrong or questions need to be answered concerning App functionality or non-functioning Apps.

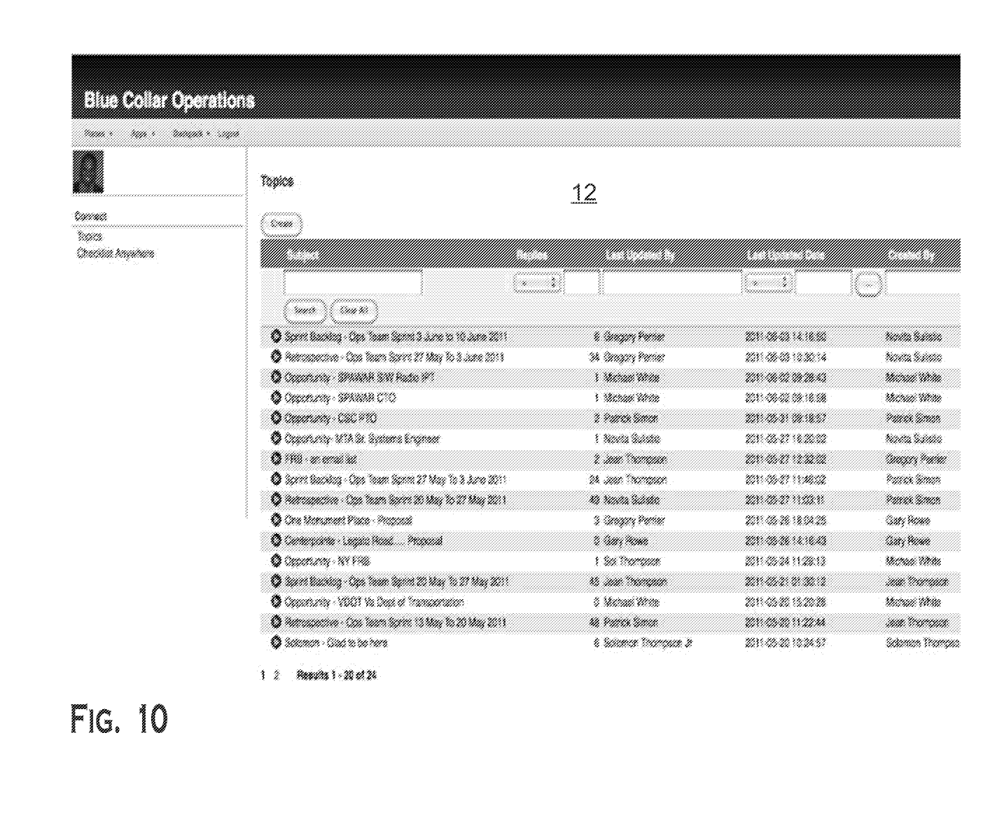

This collaboration system 10 provides various approaches to enable a non-technical user, through a browser or smartphone to interface with the server and manipulate data and/or create new data constructs to perform many functions with respect to business automation. For example, a user may create a “virtual place” which represents an area where private collaboration and integration App usage can occur for invited members of a public Software as a Service (SaaS) cloud (as described by the National Institute of Standards and Technology (NIST)). FIG. 9, shows one optional GUI drop down menu 14 for presenting a create a virtual place menu 14. FIG. 10 shows an example of a place that has been created as interfaced with by a user via a GUI 12.

The non-technical user can also leverage standard Platform User Experience Conventions (such as icons, bar icons, or Apps) which may be arranged as follows. Leftbar services 28 may be used which represent “business units of work”. A leftbar can represent business automated functionality, accessible by a user assigned with an App Role (software representation of a “hat” that can be worn by a member of an enterprise, like HR manager or worker or, project manager etc). This functionality can be accessible via the below workflow.

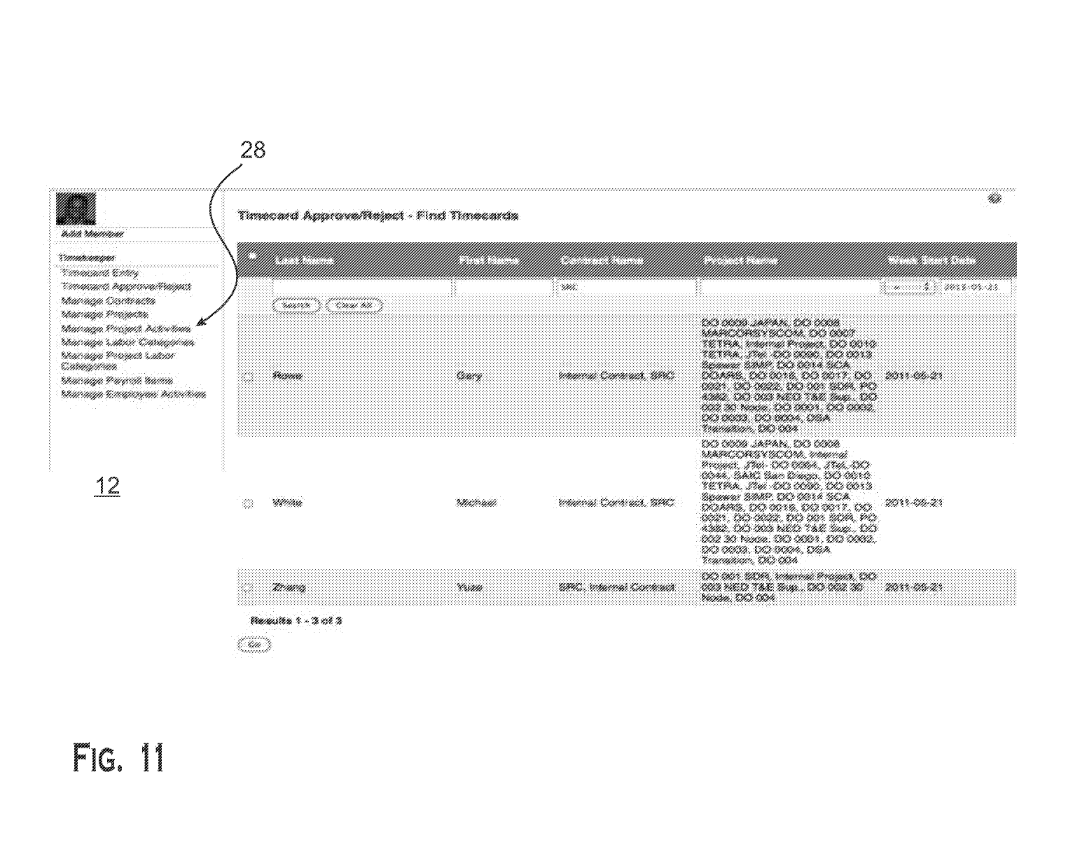

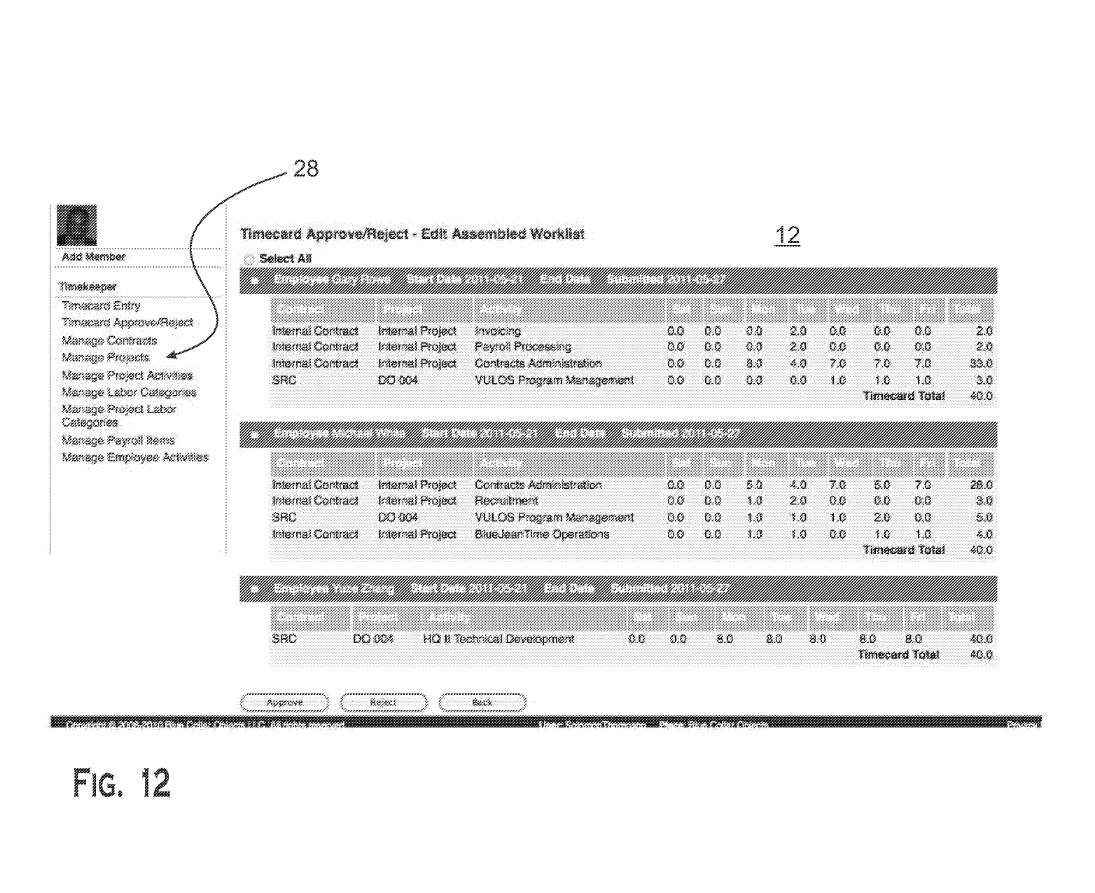

Referring to FIG. 12, an authorized user clicks desired leftbar. For example, in time and activity management system, the leftbar could be Timecard Approve/Reject. Then the system may display a “worklist” (list of time cards pending approval). This list, if long, could be searched using search criteria that can be specified for any column of the rows of data where the criteria values are “ANDed” (Boolean logic) together such that the search result on the worklist will be the set of rows for which each criteria is true within the select statement (see Structured Query Language description and syntax for more complete understanding of this example). FIG. 11 illustrates an example timecard approve/reject worklist constrained by containing “SRC” in the contract name and “Start Date=2011-05-21”.

When the authorized user finds the row representing the desired work item, a widget is clicked to get to the “Go” (which is a GUI or screen which has the details of the item(s) which may be viewed and updated if the user is authorized for that action). Referring to FIG. 12 an example of timecard approve/reject screen is shown which would preferably have sufficient information visible on the screen to enable the authorized user to make a decision to approve or reject the timecard(s).

This pattern of clicking on a leftbar 28, searching through a work list to locate the work item desired while leveraging an extremely intuitive search approach and then choosing an item by clicking the green arrow (usual case but in some cases other controls are used to handle working with collections of items simultaneously as in the example with checkboxes vs. green arrows) to get to the Go screen to do the actual work, is preferably consistent throughout the collaboration system 10 which may be accessed via a cloud both in the public area or the private virtual places that can be created by users. This pattern of navigation and workflow configuration illustrates how that system's collaborative components/tools provide the non-technical end user power in creating new, automated access-controlled workflows (or Apps) without writing a line of program code (as would be written in a programming language like Java or C).

The user can preferably leverage standard virtual place characteristics where all data collected from any App subscribed to within a place is available within the Place to users authorized to query that data and the data resides in a schema designed to integrate data across App contexts. There is an instant App integration that occurs when a new App is created for the Platform and subscribed to by the non-technical end user.

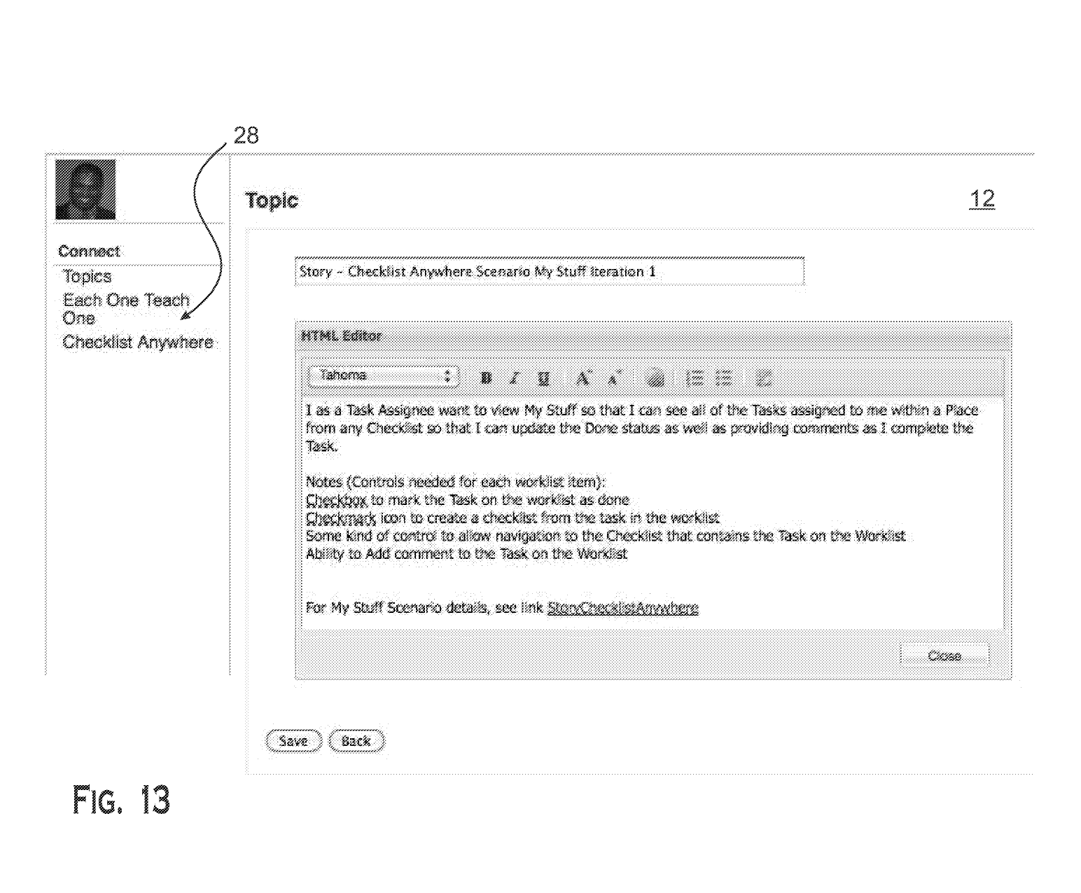

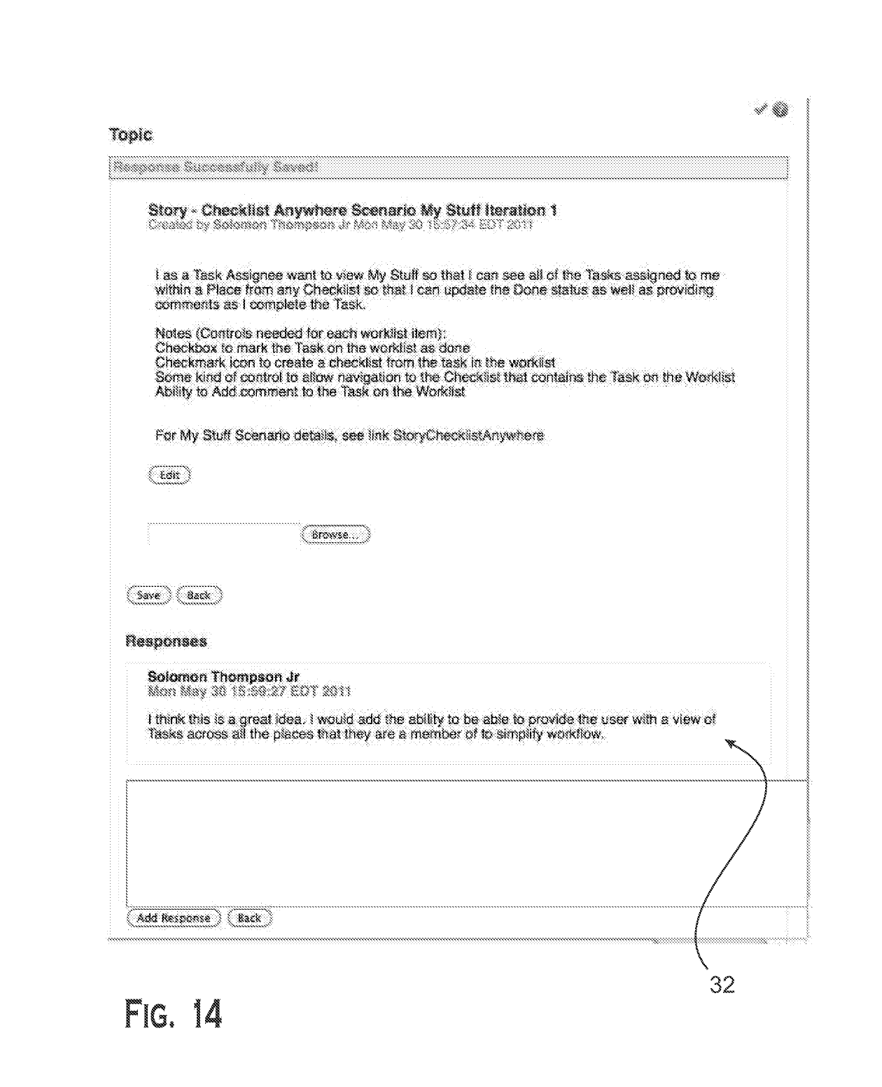

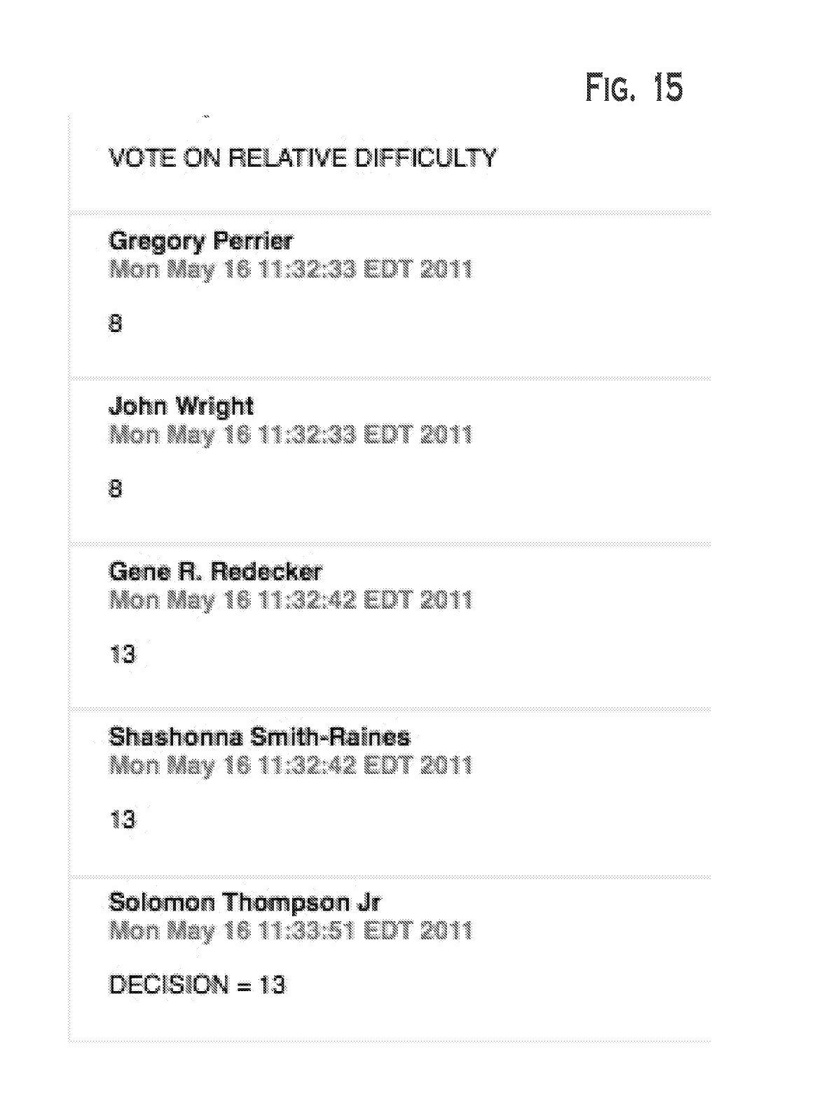

FIG. 13 illustrates a sample screen/GUI 12 that can be used when a user creates a topic. The create a topic interface may include web content composed of text and graphics (similar to wiki topics) which could describe ideas or proposals. Referring to FIG. 14 a created topic interface may be directed to collecting feedback 32 on any topic to leverage crowd inputs to mature the idea of the topic owner. Similarly, referring to FIG. 15, the create a topic interface may be used to create an election event to decide on actions related to the topic. Furthermore, referring to FIG. 8, a checklist can be inserted into a topic where each task can be assigned to one or more members of the virtual place (and interface showing such a situation is illustrated in FIG. 16). By creating a checklist or plan for implementing the topic where each task can be assigned to one or more members of the Place (or virtual place) a user can better coordinate between members of the group or project team.

As discussed above, each of the members may have their task automatically appear in their virtual backpack such that each task assignee can view their task in a My Stuff view of their virtual backpack. This enables users to preferably see all tasks that have been assigned to them from any checklist within the collaboration system 10. This ability to provide a task assignee a my stuff view within a virtual backpack (a metaphor for a virtual location from which a user can look at stuff available across places independent of the users current place within the collaboration system 10) context enabling a view of all tasks that have been assigned to them from any checklist within any place/virtual place within the collaboration system 10.

Similarly, a user can create an election event to decide on actions related to any task within the checklist. This allows members to provide input as to whether each of the steps/tasks in the checklist makes sense, should be pursued, or should be modified.

The user may also create templates for topics, checklists and elections. By establishing topic naming conventions, topic content starting points for structure and content can be established as follows: (1) establish checklist naming conventions, checklist content starting point to leverage known steps/tasks needed to solve certain problem types; (2) establish election naming conventions, ballot content or structure starting point, ability to reuse electorates (parties invited to previous elections) as starting points for configuring an election for a given context (for example topic, task or future unanticipated platform artifact).

The collaboration system 10 preferably also allows users to leverage worklist search filters, generated as part of establishing templates, to provide worklist views. The utility of this becomes more apparent when considered in conjunction with the following two scenarios.

### Example 1

The naming convention imposed as a product of using a template to create an artifact (like a topic, checklist or election) registers the convention as a worklist search filter. This search filter (or string) can be chosen when on a worklist and the choice causes the worklist to only show work items which begin with the filter. For example, a non-technical end user may decide to create an opportunity topic template to capture information about an opportunity, an election template to decide whether to pursue and opportunity (like bid, no-bid), establish steps needed to close the opportunity and track progress to closure (leveraging an opportunity checklist template). By creating these templates, the user causes the system to generate filters (like “Opportunity—” for the topic, checklist, and election) for each of the worklists (topics, checklist anywhere and decide anywhere respectively). When on the topics worklist, if the user chooses the opportunity filter, then the worklist will only show topics whose name start with “opportunity—”. This topic would preferably have associated with it the checklist(s) or plan(s) associated with the opportunity showing the status and steps left to closing the opportunity. Furthermore, there is either the evidence of a previous bid/no-bid decision or at any point at time, the ability to have a bid/no-bid election. As such, a non-technical end user can without writing any software, establish an automated workflow for identifying, deciding to pursue, and then track the progress of a business opportunity (essentially an opportunity management App).

### Example 2

Suppose the non-technical end user is a home owner and has established a home improvement template. This means that a naming convention would be established, say “home improvement—” and as such, filters established for topics, checklists and elections (depending upon what the non-technical end user wants included). The home improvement topic template can be structured in sections such that the user can capture the purpose, description and other details of the improvement project like where to acquire the materials or whatever. The home improvement election template could be something like, do it yourself, hire contractor, or too expensive add to wish list. The home improvement checklist could include items such as research how to websites, create materials list, get pricing for materials, get bids from contractors etc. With these templates created, the user can create real topics for different home improvement projects. If the non-technical end user, when accessing the topics leftbar 28 decides that they only want to see the home improvement related topics, the home improvement filter can be chosen, and suddenly the user has an environment tailored to proposing, deciding upon, planning and tracking these projects. Additionally, all users that are members of the private place/virtual place have access to the generic topics leftbar, the templates and the filtering capability. Also, place members who have been assigned tasks can see them from their my stuff task worklist.

It is also preferred that a user can create named topics leftbars (user controlled App service creation). This capability leverages the capabilities described above regarding creating topics and optionally, associated elections and checklists, and then templates for these artifacts to add a powerful piece to the non-technical end user empowerment objective: the ability to configure new leftbars that where access is granted to a subset of place members, and as such, enable non-technical users to create new, access-controlled, automated business workflows without writing any program code.

The combination platform features of leftbar/worklist/Go screen and the ability to create topics with associated election/decisions and checklists, combined with giving the non-technical end users the power to define templates and the resulting worklist filters equip non-technical end users with unprecedented capability to simply create automated workflows coordinating the activities of members of the places/virtual places they create. When combined with the capability to configure additional leftbars with inherent ability to define roles for the leftbars and assign users to roles, the platform empowers a non-technical end user to create simple but powerful App functionality without writing any program code.

An important aspect of the collaboration system 10 is the system's preferred ability to empower a non-technical end user to create and maintain automated business workflows without writing any program code. This may be achieved using customized workflow design and enforced conventions throughout the collaboration system 10 and by using provided services and App-specific services.

For some users, the best approach to establishing new workflow is to, essentially, select a kind of work, narrow the (worklist) data, & work on a specific item to produce a result. This type of conceptual approach is described in the following table:

| business | | | |
|---|---|---|---|
| perspective | | application | |
| or purpose | description | architecture tier | design concept |
| select kind of | user selects leftbar | communication | consistent intuitive workflow |
| work | for a business-unit-of-work from | channel | |
| | choices on the leftbar | | |
| narrow the | user searches worklist | communication | consistent intuitive workflow |
| (worklist) | for that leftbar, & narrows to the | channel | |
| data | list to the specific work data the | | |
| | user wants to work on | | |
| work on a | users goes to work screen | communication | consistent intuitive workflow |
| specific item | and interacts with the application | channel | |
| | to perform the work desired | | |
| application's | when user enters data, | business services | 1. the application's business |
| business code | communication channel sends | | logic for a leftbar is |
| | message to a business service | | implemented as a business |
| | | | service |
| | | | 2. business services are SOA |
| | | | style code artifacts receiving |
| | | | an xml request messages and |
| | | | replying with a |
| | | | corresponding xml response |
| | | | message |
| application's | business service uses | business services | 1. validators (inside the |
| error checking | “validators” to insure that xml | | business services) perform |
| | request messages either from | | all error checking using the |
| | user inputs or web service calls | | data in the messages. |
| | from other systems are valid & | | |
| | prevent data errors | | |
| application's | business services uses database | persistence | 1. database structure and |
| business data | access code to collect | services | access are encapsulated from |
| store | appropriate business data for | | the business service. |
| | interaction with user | | |
| application's | application gatekeeper insures | communication | 1. a user can only see the |
| handling of | that a user can only use the | channel, business | leftbars that they have rights |
| user rights & | business services authorized for | services | for. |
| roles | the roles (personas) that the user | | 2. a business service cannot |
| | plays | | be used by an unauthorized |
| | | | user. |

Common Building Blocks/Multiple Contexts/Different Combinations

The idea is that folks could figure out different ways to quickly combine work to be done description, collaborative inputs about it, checklists detailing specific items needing actions, and various kinds of votes or crowd inputs to quickly organize a group effort and guide to completion in highly specialized, innovative ways based upon their own expertise about the work to be done or the problem to be solved.

In addition to allowing people to use this tool in completely dissimilar business areas, different organizations in the same business area might combine the organizational elements in different and possibly unexpected ways and, based on their own expertise, leverage their unique techniques to provide a competitive advantage. Alternatively, people working in different enterprise might elect to share process ideas, again, possibly leading to unexpected uses and the possibility of achieving competitive advantage over traditional enterprises. Besides enabling new ways for groups to organize work for workers within the same enterprise, collaboration system 10 also provides new ways to organize work efforts involving participants from many companies.

### Exemplary Use by Event Planner/Distributed Planning

Wedding Planner Example

There are many kinds of business that are essentially different types of event planners. What follows is an example of how the artifacts in the tool for a wedding planner could be used. A wedding planner meets with a prospective client and, using an iPad, shows a marketing place set-up with topics describing various aspects of the wedding planning services that he provides. As they discuss various aspects, he sets up a new place for this potential wedding plan, and populates this new place (also referred to as a virtual place) quickly with some of the planning topics using predefined wedding-templates for such things as: destination possibilities, ambiance, calendar complexities, event logistics, VIP lists (like family items).

As part of the discussion, some checklists involving various follow up activities are created and another meeting is planned for the wedding planner to provide some more details and for the potential client to decide whether to proceed or not. In the follow up meeting, specific fees and services were discussed, and an additional idea, such as involving the wedding party in some of the planning, is also documented in a topic. A checklist can be created for the bride to inform the bridesmaids and the wedding planner to invite the bridesmaids to this specific-wedding's private place once all were informed and the initial payment is received.

The bride can decide to proceed and the wedding planning begins. As the planning proceeds, various additional topics are created and additional people involved in the wedding are invited to the place and provide inputs and respond to items. For example, in addition to the bridesmaids, the florist, the chef, the parents, other close friends of the bride all join the wedding's place and provide inputs. At times, votes are taken on items such as potential menus are voted in by the bridesmaids. The bridesmaids and some friends get more involved in planning a pre-wedding party.

In addition to providing for distinctive planning, the wedding's place becomes kind of a fun place for guests to keep apprised of wedding plans and exchange information. Votes are used frequently to aggregate opinions. There is some fun and joking involved. This is easy to do since all of the application features are preferably accessible by portable electronic devices, such as iPhones, tablets, readers, iTouch devices, smart phones, laptops, etc.

After the planning-effort completes and the wedding occurs, the wedding planner invites everybody who participated to vote on successes and improvement topics. Additionally, the wedding planner ends access for service providers but leaves the wedding-place accessible to the wedding guests that had access for whatever additional uses they may have in mind after the wedding.

Convention Planner Example

There are many kinds of business that are different forms of an event planner—so below is one preferred method for using the artifacts in the tool for a convention planner. An example of how complex a convention plan may be is shown by reviewing some of the areas where organization is needed. For example, planning an eight day event for a biotech industry group can involve organizing speeches, classes, panel discussions, and a vendors booth area hosted at a convention center and meeting room in four nearby hotels. To collaborate using the collaboration system 10, a private place could be set-up for the general conference and, items added to the conference agenda would become topics with their own comments by involved parties and checklists itemizing the various tasks needed to bring the conference agenda item up to ready-to-include. Likewise, there could be a matching set of topics to handle the physical logistical aspects of the conference agenda items, with their own sets of checklists referencing the people responsible for physical setup.

Eventually, all of the people involved in creating the conference would be members of this place. In the cases where some vendors wanted privacy for their planning, they could set up their own place and use the same organizing artifacts to manage their own effort.

### Distributed Site Visitors Business

Landscaping Services Provider

There are many kinds of business that are different forms site visitor business. What follows is an example of how the collaboration system 10 can be used as by a landscaper, a kind of distributed service business.

A landscaper visits a house and is given a tour of the property by a spouse and points out some problem areas such as a high erosion area on a hill and a barren area that is heavily shaded. The landscaper takes some iPhone pictures of the problem areas and interviews the spouse to get an idea of the kinds of solutions that might fit based on budget, taste, and maintainability needs. As part of this, using an iPad or other portable electronic device, the landscaper creates a private place for the residence and adds a topic and from a landscaping template used to jot down some quick notes based upon the information gained.

After the session, in the car before beginning to travel to the next client, the landscaper uploads all of the iPhone pics, creates a topic for each of them, adds a couple checklists identifying specific things to look into, such as “determine any covenant restrictions for trees”, “consider regrading if permits can be easily obtained”, etc, etc. The landscaper “invites” the landscape designer who works out of her house to join the place, the designer looks at the checklists and works through them that afternoon while landscaper is talking to the next client.

The next day, the landscaper creates a set of topics each containing alternative solutions with uploaded pictures of proposed kinds of plantings, price alternatives, and a checklist of options. Later the landscaper meets with both spouses, using the iPad, shows the alternative solutions, and reaches agreement on what is desired. The landscaper “invites” both spouses to join their private-place so they can review the desired work.

Back at the office, a planner creates topic for each work element (such as “High Erosion Area Work Effort” and “Heavily Shaded Area Work Effort”) along with descriptions, references to other topics, and uploaded pictures of the kinds of plants selected. In addition, checklists for the various efforts involved are created for each topic also identifying the individuals that will do the work and the desired different day/times.

Each day, laborers using their company provided iPhones or other devices check their virtual backpack to see the tasks assigned for that day, look at the checklists and topics, plan their day and drive directly to the various work sites. Once their work is complete, the laborers take pictures of the completed work and upload it to the appropriate work topics. The homeowners may visit the site often, remain aware of the progress and a couple times ask questions using the blog topic in their private place. This allows the questions to be answered the next day by the home office supervisor/planner.

When the work completes, the landscaper visits the property, examines the work, and discusses the results with the homeowners. They are interested in having the landscaper fertilize and use weed killer at specified intervals and the landscaper adds additional topics to their place for this new annual, ongoing work.

In addition, the homeowners are asked to vote on what went well, what might be better. Also, the homeowners remain members of their place and visit it to ask questions about other potential services or even questions about plant care.

### Business Incubator/StartUps

Mentor Coaching Example

A university business incubator organization provides mentors that provide a wide swath of business consulting to entrepreneurs during the first fifteen months after angel investment. The incubator administrator establishes a separate (private) place for each entrepreneur and recruits the appropriate set of business executives, directors, business specific domain experts, and mentors whom also join the entrepreneurs private place.

Distributed meetings are conducted using unique topics that are set-up as the mentoring engagements unfold. Best practices applicable to the specific entrepreneur are identified (using topics and checklists). Specific checklists involving mentors and the entrepreneur are set up in review meetings that are monitored and added to asynchronously by all.

Anonymous voting by directors and business executives can be used to measure perceived effectiveness of progress, risks, and needs. Once the engagement completes, the participants vote on what went well and what needed improvement and this result is added to an aggregation that is part of determining future best practices. Incubator administrator is a member of all of the private places and uses his knowledge of the results to help flesh out best practices with all of the mentors in a separate mentors-place.

It is recognized by those skilled in the art that changes may be made to the above described collaboration system 10, its software with which it is implemented, or the hardware systems and networks on which it is implemented, without departing from the broad inventive concept thereof. It is understood, therefore, that this invention is not limited to the particular embodiments disclosed, but is intended cover all modifications which are within the spirit and scope of the invention as defined by the above specification, the appended claims and/or shown in the attached drawings.

What is claimed is:

1. A method of automating aspects of charging and receiving payments in exchange for access to a user's content on a collaboration system configured for use on a server accessible by a network such that paid access can be readily established without requiring the independent integration of payment receipt and tracking software by the user and without requiring the user to select and determine software compatibility of the same for use on the server, comprising:
providing at least one software module stored on a non-transitory computer readable storage medium which provides collaboration tools which can be accessed by the user via the network, the collaboration system provides a plurality of virtual places each of which is configured to require different credentials for access and each having a graphical user interface associated therewith, each virtual place being originally created by a first user who can one of invite and allow other users to enter the virtual place on the network to access data stored therein and/or use any of the collaborative tools available within the virtual place,
the network provides a collaboration tool to the first user which allows the first user to set payment terms for access by other users to the virtual place created by the first user, this allows the first user to by selecting a single collaborative tool modify the virtual place so that the virtual place charges for access without the first user having to separately and independently identify and select appropriate software for virtual shopping carts, merchant services, and payment tracking, this allows the first user to by using a single tool change the virtual place to then require payment for access to the virtual place,
the network automatically monitoring the payment terms and allowed access to the virtual place and being configured to readily receive and track payments from other users who wish to pay and receive access to the virtual place owned by the first user.

2. The method of claim 1, wherein the step of the network providing the collaboration tool to the first user which allows the first user to set payment terms for access to the virtual place by other users automatically credits a portion of received payments to the first user and another portion of the received payments to an owner of the network.

3. The method of claim 2, wherein the step of the network providing the collaboration tool to the first user which allows the first user to set payment terms for access to the virtual place owned by the first user further allows the first user to change the virtual place automatically without having to arrange for compatible technology for integrating payment processing and reporting.

4. The method of claim 2, further comprising automatic tracking by the network of purchases resulting from the sharing of information by other users and crediting a portion of the revenue from the purchases to the one of the other users that generated the sale.

5. The method of claim 4, further comprising the network allowing other users to share information regarding the virtual place via electronic communication containing information identifying the identity of the other user generating the electronic communication.

6. The method of claim 5, wherein the step of allowing other users to share information regarding the virtual place owned by the first user further comprises the electronic communication being in the form of a link embedded in an email which can be selected by a recipient of the email.

7. The method of claim 6, further comprising the at least one software module automatically detecting when the link is selected.

8. The method of claim 5, wherein the step of allowing other users to share information regarding the virtual place owned by the first user further comprises the electronic communication is in the form of a link embedded in a blog which can be selected by a reader of the blog.

9. The method of claim 8, further comprising the at least one software module automatically detecting when the link is selected.

10. The method of claim 1, further comprising:
allowing other users who are not an owner of the virtual place to send information about the virtual place to another via an electronic communication,
automatic monitoring by the network as to whether the another person purchases access to the virtual place owned by the first user for which information was shared by the other users,
automatic tracking by the network of purchases resulting from the sharing of information by the other users and crediting a portion of the revenue from the purchases to the one of the other users that generated the sale as a result of the electronic communication generated prior to the sale.

11. A method of automating aspects of charging and receiving payments in exchange for access to a user's content on a collaboration system configured for use on a server accessible by a network such that paid access can be readily established without requiring the independent integration of payment receipt and tracking software by the user and without requiring the user to select and determine software compatibility of the same for use on the server, comprising:
providing at least one software module stored on a non-transitory computer readable storage medium which provides collaboration tools which can be accessed by the user via the network, the collaboration system provides a plurality of virtual places each of which is configured to require different credentials for access and each having a graphical user interface associated therewith, each virtual place being originally created by a first user who can one of invite and allow other users to enter the virtual place on the network to access data stored therein and/or use any of the collaborative tools available within the virtual place,
the network provides a collaboration tool to the first user which allows the first user to set payment terms for access by other users to the virtual place created by the first user, this allows the first user to by selecting a single collaborative tool modify the virtual place so that the virtual place charges for access without the first user having to separately and independently identify and select appropriate software for virtual shopping carts, merchant services, and payment tracking, this allows the first user to by using a single tool change the virtual place to then require payment for access to the virtual place,
the network automatically monitoring the payment terms and allowed access to the virtual place and being configured to readily receive and track payments from other users who wish to pay and receive access to the virtual place owned by the first user,
allowing other users who are not an owner of the virtual place to send information about the virtual place to another via an electronic communication,
automatic monitoring by the network as to whether the another person purchases access to the virtual place owned by the first user for which information was shared by the other users,
automatic tracking by the network of purchases resulting from the sharing of information by the other users and crediting a portion of the revenue from the purchases to the one of the other users that generated the sale as a result of the electronic communication generated prior to the sale.

12. The method of claim 11, wherein the step of the network providing the collaboration tool to the first user which allows the first user to set payment terms for access to the virtual place by other users automatically credits a portion of received payments to the first user and another portion of the received payments to an owner of the network.

13. The method of claim 12, wherein the step of the network providing the collaboration tool to the first user which allows the first user to set payment terms for access to the virtual place owned by the first user further allows the first user to change the virtual place automatically without having to arrange for compatible technology for integrating payment processing and reporting.

14. The method of claim 12, further comprising automatic tracking by the network of purchases resulting from the sharing of information by other users and crediting a portion of the revenue from the purchases to the one of the other users that generated the sale.

15. The method of claim 14, further comprising the network allowing other users to share information regarding the virtual place via electronic communication containing information identifying the identity of the other user generating the electronic communication.

16. The method of claim 15, wherein the step of allowing other users to share information regarding the virtual place owned by the first user further comprises the electronic communication being in the form of a link embedded in an email which can be selected by a recipient of the email.

17. The method of claim 16, further comprising the at least one software module automatically detecting when the link is selected.

18. The method of claim 15, wherein the step of allowing other users to share information regarding the virtual place owned by the first user further comprises the electronic communication is in the form of a link embedded in a blog which can be selected by a reader of the blog.

19. The method of claim 18, further comprising the at least one software module automatically detecting when the link is selected.
